(19) United States
(12) Patent Application Publication
(10) Pub. No.: US 2025/0315866 A1
(43) Pub. Date: Oct. 9, 2025

(54) ROBUST VIRTUAL COMMUNICATIONS INFORMATICS PLATFORM

(71) Applicant: Highspot, Inc., Seattle, WA (US)

(72) Inventors: Justin David Kelly, Seattle, WA (US); Matthew Edward Grosso, Seattle, WA (US); Bala Vignesh Charllo, San Jose, CA (US); Venkateswara Sura, Kenmore, WA (US)

(21) Appl. No.: 19/171,024

(22) Filed: Apr. 4, 2025

Related U.S. Application Data
(60) Provisional application No. 63/574,580, filed on Apr. 4, 2024.

(51) Int. Cl. G06Q 30/02

(52) U.S. Cl. CPC G06Q 30/0281

(57) ABSTRACT

Systems and methods are disclosed comprising instructions to retrieve time-indexed data comprising at least one upcoming virtual communication event accessible to participant users associated with a user identifier, identify one or more prior virtual communication events associated with the at least one upcoming virtual communication event, extract a content signal set indicating historical event contents pertinent to the at least one upcoming virtual communication event from stored audio signals of the one or more prior virtual communication events, determine at least one recorded digital artifact representing supplementary event contents that are similar to the extracted content signal set of the one or more prior virtual communication event, cause a generative machine learning model to generate a natural language response indicating recommended user actions during the at least one upcoming virtual communication event, and generate for display the determined at least one recorded digital artifact and the generated natural language response.

### CROSS-REFERENCE TO RELATED APPLICATION(S)

This application is a continuation of U.S. Application No. 63/574,580, filed on Apr. 4, 2024, entitled AUTOMATED MEETING DOSSIERS IN CONTENT MANAGEMENT PLATFORMS, which is hereby incorporated by reference in its entirety.

### BACKGROUND

A large language model (LLM) is a type of machine learning model designed for natural language processing tasks, such as language generation, and these models have many parameters and are trained using self-supervised learning on large text datasets. The most advanced LLMs are generative pretrained transformers (GPTs), and modern models can be fine-tuned for specific tasks or guided by prompt engineering, allowing them to develop predictive abilities related to syntax, semantics, and ontologies in human language corpora.

### BRIEF DESCRIPTION OF THE DRAWINGS

Detailed descriptions of implementations of the present invention will be described and explained through the use of the accompanying drawings.

FIG. 1 is a system diagram illustrating an example of a computing environment in which the disclosed system operates in some implementations.

FIG. 2 is a block diagram that illustrates a content informatics platform that can implement aspects of the present technology.

FIG. 3 is a flow diagram that illustrates an example process for generating an informatics interface in accordance with some implementations of the disclosed technology.

FIG. 4 is a flow diagram that illustrates an example process for creating time-indexed sequence in accordance with some implementations of the disclosed technology.

FIG. 5 is a flow diagram that illustrates an example process for extracting content signals of virtual communication events in accordance with some implementations of the disclosed technology.

FIG. 6 is a flow diagram that illustrates an example process for mapping virtual communication events in accordance with some implementations of the disclosed technology.

FIG. 7 is a flow diagram that illustrates an example process for generating personalized recommendations in accordance with some implementations of the disclosed technology.

FIG. 8 is a flow diagram that illustrates an example process for generating a query response in accordance with some implementations of the disclosed technology.

FIGS. 9A-9B illustrate example access methods for an informatics interface in accordance with some implementations of the present technology.

FIGS. 10A-10E illustrate an example informatics interface in accordance with some implementations of the present technology.

FIG. 11 illustrates an example digital room interface in accordance with some implementations of the present technology.

FIG. 12 illustrates an example timeline window in accordance with some implementations of the present technology.

FIG. 13 illustrates an example chat interface in accordance with some implementations of the present technology.

FIG. 14 illustrates a layered architecture of an artificial intelligence (AI) system that can implement the ML models of the content informatics platform in accordance with some implementations of the present technology.

FIG. 15 is a block diagram of an example transformer that can implement aspects of the present technology.

FIG. 16 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Sales professionals within an organization are tasked with the management of multiple accounts, encompassing both existing and prospective customers. This management process necessitates numerous meetings throughout the deal cycle and beyond, each requiring meticulous preparation. The preparation process is inherently time-consuming due to the high frequency of meetings and the diverse range of topics and content that must be addressed. Existing systems predominantly rely on manual evaluation processes, which are inefficient and prone to errors. Consequently, significant challenges arise in maintaining context across various accounts and meetings. Sales professionals must manually recall specific details about each customer, including their unique needs, preferences, and previous interactions, which is both time-consuming and error prone.

Additionally, the tracking of action items from each meeting is critical to ensure follow-through on commitments and to sustain momentum in the sales process. However, the manual nature of these processes makes it difficult to manage the sheer volume of tasks effectively. Moreover, the ability to recall past objections raised by customers is essential for addressing concerns and advancing the sales process. Without an efficient system for tracking these objections, providing satisfactory responses in subsequent meetings becomes challenging. Furthermore, manually remembering all resources previously shared with customers, such as presentations, product information, and follow-up materials, is vital for maintaining a coherent and professional relationship. These complexities, exacerbated by the inefficiencies of manual processes, not only impede the efficiency of sales professionals but also adversely affect the quality of customer interactions. The inability to effectively manage these aspects can result in missed opportunities, decreased customer satisfaction, and ultimately, a negative impact on the organization's overall sales performance.

Disclosed herein are systems and methods for generating pre-emptive informatics for virtual communication events (e.g., online teleconference meetings). The disclosed system is designed to retrieve time-indexed data (e.g., calendar-scheduled events) associated with a user identifier. By leveraging this metadata, the system can identify previous virtual communication events that are pertinent to the upcoming events. The system can use stored audio signals (e.g., voice recording, audio-enabled video recording, and/or the like) of the prior virtual communication events to extract historical content relevant to the forthcoming virtual communication events.

The system can identify supplementary event contents that are analogous to the extracted historical content (e.g., related documents and previous meeting notes). For example, the system can use the extracted historical content and the identified supplementary event contents to generate, and display, a natural language response (e.g., via a generative machine learning model) that provides recommended user actions for the upcoming virtual communication events. Accordingly, the system enhances user readiness for virtual communication events by delivering contextually relevant historical data and actionable insights, thereby improving the precision and productivity of user interactions.

For illustrative purposes, examples are described herein in the context of computer systems for generating content informatics associated with virtual communication events (e.g., online teleconference meetings). However, a person skilled in the art will appreciate that the disclosed system can be applied in other contexts. For example, the disclosed system can be used within data management systems to as a dynamic informatics interface that provides quick and relevant content information to end users and/or consumers.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Example Computing Environment

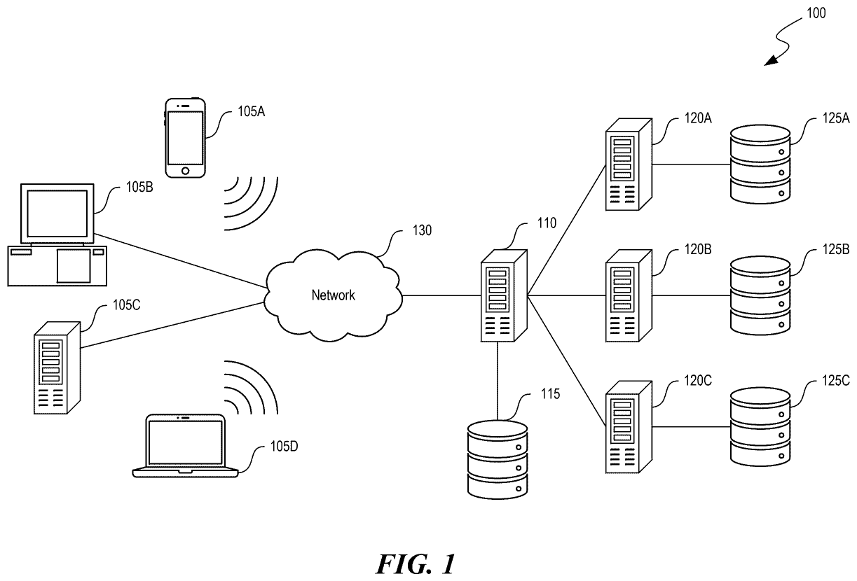

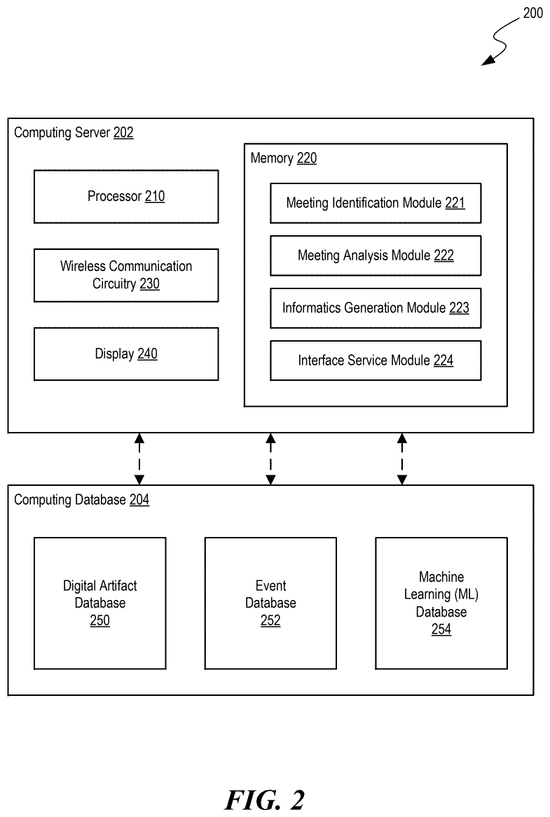

FIG. 1 is a system diagram illustrating an example of a computing environment in which the disclosed system operates in some implementations. In some implementations, environment 100 includes one or more client computing devices 105A-D, examples of which can host the content informatics platform 200 of FIG. 2. Client computing devices 105 operate in a networked environment using logical connections through network 130 to one or more remote computers, such as a server computing device.

In some implementations, server 110 is an edge server which receives client requests and coordinates fulfillment of those requests through other servers, such as servers 120A-C. In some implementations, server computing devices 110 and 120 comprise computing systems, such as the content informatics platform 200 of FIG. 2. Though each server computing device 110 and 120 is displayed logically as a single server, server computing devices can each be a distributed computing environment encompassing multiple computing devices located at the same or at geographically disparate physical locations. In some implementations, each server 120 corresponds to a group of servers.

Client computing devices 105 and server computing devices 110 and 120 can each act as a server or client to other server or client devices. In some implementations, servers (110, 120A-C) connect to a corresponding database (115, 125A-C). As discussed above, each server 120 can correspond to a group of servers, and each of these servers can share a database or can have its own database. Databases 115 and 125 warehouse (e.g., store) information such as claims data, email data, call transcripts, call logs, policy data and so on. Though databases 115 and 125 are displayed logically as single units, databases 115 and 125 can each be a distributed computing environment encompassing multiple computing devices, can be located within their corresponding server, or can be located at the same or at geographically disparate physical locations.

Network 130 can be a local area network (LAN) or a wide area network (WAN) but can also be other wired or wireless networks. In some implementations, network 130 is the Internet or some other public or private network. Client computing devices 105 are connected to network 130 through a network interface, such as by wired or wireless communication. While the connections between server 110 and servers 120 are shown as separate connections, these connections can be any kind of local, wide area, wired, or wireless network, including network 130 or a separate public or private network.

### Content Informatics Platform

FIG. 2 is a block diagram that illustrates a content informatics platform 200 (“system 200” or “platform 200”) that can implement aspects of the present technology. The components shown in FIG. 2 are merely illustrative, and well-known components are omitted for brevity. As shown, the computing server 202 includes a processor 210, a memory 220, a wireless communication circuitry 230 to establish wireless communication and/or information channels (e.g., Wi-Fi, internet, APIs, communication standards) with other computing devices and/or services (e.g., servers, databases, cloud infrastructure), and a display 240 (e.g., user interface). The processor 210 can have generic characteristics similar to general-purpose processors, or the processor 210 can be an application-specific integrated circuit (ASIC) that provides arithmetic and control functions to the computing server 202. While not shown, the processor 210 can include a dedicated cache memory. The processor 210 can be coupled to all components of the computing server 202, either directly or indirectly, for data communication. Further, the processor 210 of the computing server 202 can be communicatively coupled to a computing database 204 that is hosted alongside the computing server 202 on the core network 106 described in reference to FIG. 1. As shown, the computing database 204 can include a digital artifact database 250, an event database 252, and a machine learning (ML) database 254.

The memory 220 can comprise any suitable type of storage device including, for example, a static random-access memory (SRAM), dynamic random-access memory (DRAM), electrically erasable programmable read-only memory (EEPROM), flash memory, latches, and/or registers. In addition to storing instructions that can be executed by the processor 210, the memory 220 can also store data generated by the processor 210 (e.g., when executing the modules of an optimization platform). In additional, or alternative, embodiments, the processor 210 can store temporary information onto the memory 220 and store long-term data onto the computing database 204. The memory 220 is merely an abstract representation of a storage environment. Hence, in some embodiments, the memory 220 comprises one or more actual memory chips or modules.

As shown in FIG. 2, modules of the memory 220 can include a meeting identification module 221, a meeting analysis module 222, an informatics generation module 223, and an interface service module 223. Other implementations of the computing server 202 include additional, fewer, or different modules, or distribute functionality differently between the modules. As used herein, the term “module” and/or “engine” refers broadly to software components, firmware components, and/or hardware components. Accordingly, the modules 221, 222, 223, and 224 could each comprise software, firmware, and/or hardware components implemented in, or accessible to, the computing server 202.

In some implementations, the content informatics platform 200 can include a time-indexed data management system (alternatively referred to as “calendar system”) that is configured to maintain a list of past and upcoming virtual communication events (e.g., online teleconference meetings, remote messaging applications, and/or the like). For example, the content informatics platform 200 can include a calendar system that is configured to record online meeting events on a virtual calendar shared between authorized users. In some implementations, the time-indexed data management system can be an external service that is coupled to the platform 200. For example, the time-indexed data management system can be maintained by a third-party provider (e.g., Google Calendar, Microsoft Outlook, and/or the like). An end user can trigger the platform 200 to link an external virtual calendar (e.g., third-party managed calendar) with the platform 200 to enable one or more event data processing steps, as further described herein. In additional or alternative implementations, the time-indexed data management system can be integrated into the platform 200 or maintained locally on one or more user devices 105.

In some implementations, the content informatics platform 200 can include a customer relationship management (CRM) system that is configured to manage relationship and interaction information associated with consumers (e.g., enterprise customers) and/or potential consumers. For example, the CRM system can monitor and/or manage financial transaction data (e.g., sales and/or marketing information) of an enterprise company. The CRM system can store objects related to entities (e.g., consumer proxies) with which an enterprise has interacted with or plans to interact with. These objects can include, for example, an account object that stores information about a customer's account, an opportunity object that stores information about a pending sale or deal, or a lead object that stores information about potential leads for sales or marketing efforts. In some implementations, the platform 200 can automatically update objects within the CRM system using a machine learning model and/or an artificial intelligence agent within the platform 200. In some implementations, the CRM system can be an external service that is coupled to the platform 200. In additional or alternative implementations, the CRM system can be integrated into the platform 200 or maintained locally on one or more servers.

The content informatics platform 200 is a platform associated with an organization to facilitate creation, storing, sharing, and tracking of the organization's content. Users within the organization can use any of a variety of modes of electronic communication to interact with each other and/or with people outside the organization, such as customers or potential customers, students, or collaborators. The content informatics platform 200 can facilitate or ingest data associated with these electronic communications to help manage and track the organization's activities.

Some of the electronic communications facilitated or ingested by the content informatics platform 200 include audio or videoconferencing communications. These communications are referred to generally herein as “meetings,” although they may include synchronous, asynchronous, or a combination of synchronous and asynchronous communications between two or more participants. Meetings can be conducted via videoconferencing or audioconferencing platforms, which can be provided by third-party operators or integrated into the content informatics platform 200. The videoconferencing platform or audioconference platform can support synchronous video or audio-based communication between user devices. Meetings can be recorded by any of these platforms automatically or upon instruction by a participant, such that the video recordings are stored in a repository that is accessible to the content informatics platform 200. Alternatively, recordings captured by any of a variety of third-party videoconferencing platforms, external to the content informatics platform 200, can be provided to the content informatics platform 200 for analysis.

Some implementations of the content informatics platform 200 can further enable access to content items in a content repository. The platform 200 can provide user interfaces via a web portal or application, which are accessed by the user devices to enable users to create content items, view content items, share content items, or search content items. In some implementations, the content informatics platform 200 includes enterprise software that manages access to a company's private data repositories and controls access rights with respect to content items in the repositories. However, the content informatics platform 200 can include any system or combination of systems that can access a repository of content items, whether that repository stores private files of a user (e.g., maintained on an individual's hard drive or in a private cloud account), private files of a company or organization (e.g., maintained on an enterprise's cloud storage), public files (e.g., a content repository for a social media site, or any content publicly available on the Internet), or a combination of public and private data repositories.

In an example use case, the content informatics platform 200 is a sales enablement platform. The platform can store various items that are used by a sales team or their customers, such as pitch decks, product materials, demonstration videos, or customer case studies. Members of the sales team can use the platform 200 to organize and discover content related to the products or services being offered by the team, communicate with prospective customers, share content with potential and current customers, and access automated analytics and recommendations to improve sales performance. Meetings analyzed by the platform 200 can include sales meetings, in which a member of a sales team communicates with customers or potential customers to, for example, pitch products or services or to answer questions. However, the platform 200 can be used for similar purposes outside of sales enablement, including for workplace environments other than sales and for formal or informal educational environments.

In some implementations, the digital artifact database 250 stores content items and related data. Content items stored in the digital artifact database 250 can include items such as documents, videos, images, audio recordings, 3D renderings, 3D models, or immersive content files (e.g., metaverse files). Documents stored in the content repository can include, for example, technical reports, sales brochures, white papers, books, web pages, transcriptions of video or audio recordings, presentations, or any other type of document. In some implementations, the content management system enables users to add content items in the content repository to a person collection of items. These collections, referred to herein as “spots,” can include links to content items in the content repository, copies of items in the content repository, and/or external content items (or links to external content items) that are not stored in the content repository. Users can create spots for their own purposes (e.g., to keep track of important documents), for organizing documents around a particular topic (e.g., to maintain a set of documents that are shared whenever a new client is onboarded), for sharing a set of documents with other users, or for other purposes. In some cases, users may be able to access the spot created by other users.

In some implementations, the content informatics platform 200 can maintain interaction data quantifying how users interact with the content items in the digital artifact database 250. Interaction data for a content item can include, for example, a number of users who have viewed the item, user dwell time within the item (represented as dwell time in the content item overall and/or as dwell time on specific pages or within particular sections of the content item), number of times the item has been shared with internal or external users, number of times the item has been bookmarked by a user or added to a user's collection of documents (a “spot”), number of times an item has been edited, type and nature of edits, etc. When the content repository stores files of a company or organization, the interaction data can be differentiated according to how users inside the company or organization interact with the content and how users outside the company or organization interact with it.

In some implementations, the meeting identification module 221 processes data from a linked time-indexed data management system and/or a linked CRM system to identify meetings. In some implementations, the meeting identification module 221 filters events on a user's calendar to find any meetings between the user and a person external to the user's organization and stores any such events as the “meetings” described herein. In other implementations, the meetings identified by the meeting identification module 221 can include events filtered according to any desired criteria, such as any meeting between two or more people, any meeting between people in different roles or groups in an organization, any meeting over a certain length, any meeting in which content was shared, etc.

The event database 252 stores data associated with stores data associated with meetings linked to the content informatics platform 200, such as recordings of the meetings, transcripts of the meetings, and/or meeting metadata such as a list of attendees, a title of the meeting, meeting time, etc.

The meeting analysis module 222 processes meeting recordings or transcripts to determine when the meetings address certain topics. The meeting analysis module 222 can process any communication during a meeting, such as words spoken by meeting attendees, content items shared during a meeting, items typed in a meeting chat or written (e.g., on a virtual whiteboard), or hand gestures or other non-verbal communication during a meeting.

The informatics generation module 223 assembles information output by the meeting analysis module 222 to generate an informatics interface (e.g., an interactive dossier) for a meeting. The informatics interface can include a set of information about a meeting or recommendations for content items related to a meeting. An informatics interface can be generated in advance of a meeting (e.g., the day before any meeting on a user's calendar) to help a user prepare for the meeting. An informatics interface can additionally or alternatively be generated or supplemented after a meeting has occurred to provide information about what happened during the meeting, action items or next steps resulting from the meeting, or feedback for an attendee of the meeting.

### Generative Informatics Interface

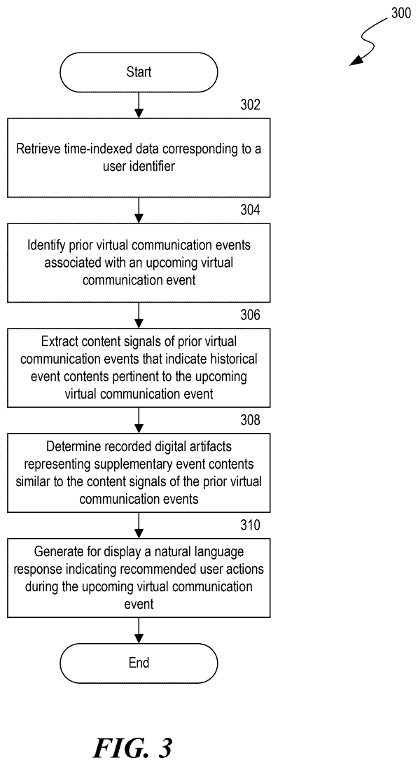

FIG. 3 is a flow diagram that illustrates an example process 300 for generating an informatics interface in accordance with some implementations of the disclosed technology. The process 300 can be performed by a system (e.g., content informatics platform 200) configured to generate recommended user actions with respect to upcoming virtual communication events (e.g., a teleconference meeting). In one example, the system includes at least one hardware processor and at least one non-transitory memory storing instructions, which, when executed by the at least one hardware processor, cause the system to perform the process 300. In another example, the system includes a non-transitory, computer-readable storage medium comprising instructions recorded thereon, which, when executed by at least one data processor, cause the system to perform the process 300.

At block 302, the system can retrieve time-indexed data (e.g., a calendar schedule information) corresponding to a user identifier (e.g., an end user of the platform 200, a participant user of virtual communication events, and/or the like). For example, the platform 200 (e.g., the meeting identification module 221) can use an Application Programming Interface (API) to communicatively request data (e.g., event scheduling information) from a linked time-indexed data management system (e.g., a calendar application, an online teleconference application, and/or the like) authorized by a participant user associated with a user identifier. In some implementations, the platform 200 can retrieve a collection of time-indexed event data from a plurality of disparate data management systems (e.g., Google Calendar, Microsoft Outlook, Zoom, Microsoft Teams, and/or the like). In some implementations, the platform 200 can pre-process the initial time-indexed data to remove duplicate and/or improper event information. In some implementations, the platform 200 can retrieve time-indexed data that comprises upcoming virtual communication events (e.g., planned and/or scheduled teleconference meetings) accessible to participant users associated with the user identifier. In additional or alternative implementations, the platform 200 can receive an event feature set comprising contextual metadata associated with the upcoming virtual communication events. For example, the platform 200 can receive (e.g., from the time-indexed data management system) identifiable information pertaining to an event title, an event location (e.g., an online webpage, a redirect shortcut, and/or the like), an event time interval, a list of event attendees (e.g., other invited users), an event type and/or categorization (e.g., a flagged event, a tagged label, and/or the like), a brief summary of planned contents for the event (e.g., an outline of discussion objectives), and/or other relevant content features associated with virtual communication events. In some implementations, the event feature set can include properties and/or attributes associated with data objects (e.g., dedicated data representation for sales leads, user accounts, transaction opportunities, and/or the like) of the CRM system.

At block 304, the system can identify prior virtual communication events (e.g., past teleconference meetings attended by a user) associated with an upcoming virtual communication event of a user. For example, the platform 200 (e.g., the meeting analysis module 222) can identify (e.g., from a remote event database 252) a set of prior virtual communication events with corresponding event feature sets that are similar to the event feature set of the upcoming virtual communication event. In some implementations, the platform 200 can apply statistical inferencing models (e.g., a machine learning model, a large language model, and/or the like) to determine prior virtual communication events comprising event feature sets similar to the event feature set of the upcoming event. For example, the platform 200 can apply a semantic encoder to generate an embedded identifier (e.g., a numerical vector) representing contents of the event feature set for the upcoming event (e.g., and the prior events). Accordingly, the platform 200 can compare the embedded identifier of the upcoming event to the embedded identifiers of the recorded prior events to identify a subset of prior events with event feature sets satisfying a similarity threshold with respect to the event feature set of the upcoming event (e.g., a Retrieval-Augmented Generation (RAG) algorithm). In some implementations, the platform 200 can retrieve (e.g., from the remote event database 252) stored audio signal data (e.g., recorded audio logs) associated with the prior virtual communication events.

At block 306, the system can extract content signals from prior virtual communication events that indicate historical event contents pertinent to upcoming virtual communication events. For example, the platform 200 (e.g., the meeting analysis module 222) can analyze stored audio signals (e.g., recorded audio log) of prior virtual communication event associated with the upcoming event to determine a set of pertinent content signals for the upcoming event. In some implementations, the platform 200 can convert the stored audio signal (e.g., digital audio data) of each prior virtual communication event into an alphanumeric signal (e.g., a text-based transcript). Accordingly, the platform 200 can apply statistical inference algorithms (e.g., a large language model, a natural language processing algorithm) to extract natural language components from the converted alphanumeric signal as pertinent content signals for the upcoming event. In some examples, the extracted content signals can include key discussion topics, user submitted commentary, financial data (e.g., an operational budget), authorization roles and/or permissions, time-indexed data sequence (e.g., a timeline), predicted user sentiments, and/or the like.

At block 308, the system can determine recorded digital artifacts (e.g., documentation, slideshow presentations, electronic files, and/or the like) that represent supplementary event contents similar to the extracted content signals of the prior virtual communication events. For example, the platform 200 (e.g., the meeting analysis module 222) can search the digital artifact database 250 for recorded digital artifacts that comprise content similarities to the extracted content signals of prior virtual communication events (e.g., associated with the upcoming virtual communication event). In some implementations, the platform 200 can apply a statistical inference algorithm (e.g., a machine learning model) to evaluate content similarities between the event features and the digital artifacts stored in the digital artifacts database 250. As an example, the platform 200 can generate an embedded identifier for the event features of prior virtual communication events and separate embedded identifiers for content data of the stored digital artifacts. Accordingly, the platform 200 can compare the embedded identifiers of the event features and the digital artifacts to identify a subset of available digital artifacts from database 250 that satisfy a content similarity threshold.

At block 310, the system can generate actionable agendas for a participant user of an upcoming virtual communication event. For example, the platform 200 (e.g., the informatics generation module 223) can cause a generative machine learning model to create a natural language response comprising recommended user-initiated actions to be performed during the upcoming event based on extracted content signals and recorded digital artifacts associated with prior virtual communication events. In some implementations, the platform 200 can generate (e.g., via the generative machine learning model) recommended user actions that includes custom discussion objectives (e.g., conversation talking points for a teleconference meeting, suggested discussion questions, and/or the like), accessing of educational resources (e.g., microlearning and/or training on content features), and/or retrieval of recorded digital artifacts pertinent to the contents of the virtual communication event (e.g., documentation, slideshow presentations, and/or the like). Accordingly, the platform 200 (e.g., the interface service module 224) can display the generated response with the recommended user agenda to a user interface associated with the user identifier.

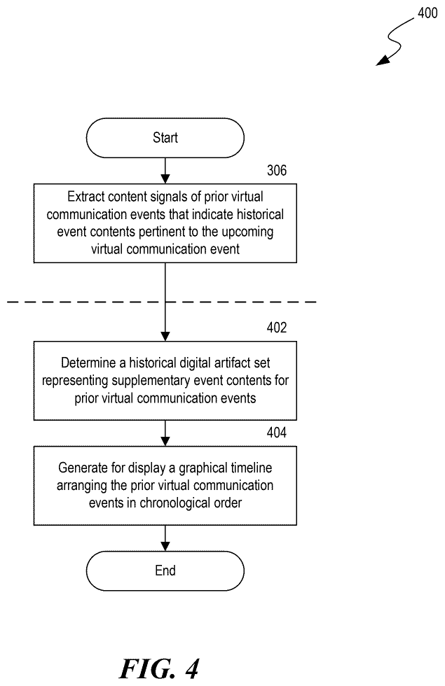

FIG. 4 is a flow diagram that illustrates an example process 400 for creating time-indexed sequence in accordance with some implementations of the disclosed technology. The process 400 can be performed by a system (e.g., content informatics platform 200) configured to generate, and display, an interactive graphical timeline that visually arranges content information associated with virtual communication events (e.g., a teleconference meeting) in chronological order. In one example, the system includes at least one hardware processor and at least one non-transitory memory storing instructions, which, when executed by the at least one hardware processor, cause the system to perform the process 400. In another example, the system includes a non-transitory, computer-readable storage medium comprising instructions recorded thereon, which, when executed by at least one data processor, cause the system to perform the process 400. In some implementations, the platform 200 can be configured to perform the process 400 alongside the example process 300 of FIG. 3. As shown in FIG. 4, the platform 200 can perform the process 400 following block 306 (or alternatively other available processing steps) of example process 300.

At block 402, the system can determine historical digital artifacts (e.g., archived digital artifacts associated with prior virtual communication events). For example, the platform 200 can retrieve (e.g., from the digital artifacts database 250) a set of historical digital artifacts that represent supplementary event contents for prior virtual communication events associated with an upcoming virtual communication event. At block 404, the system can generate a graphical timeline that arranges the prior virtual communication events (e.g., and the identified historical digital artifacts) in a chronological order. For example, the platform 200 can generate a unidirectional arrangement of historical digital artifacts (e.g., components of archived documentation, previous user conversations, prior user queries, contextual metadata, and/or the like) that are mapped in chronological order. Accordingly, the platform 200 can display (e.g., at a user interface associated with the user identifier) the graphical timeline (e.g., alongside the generated recommendations of user actions).

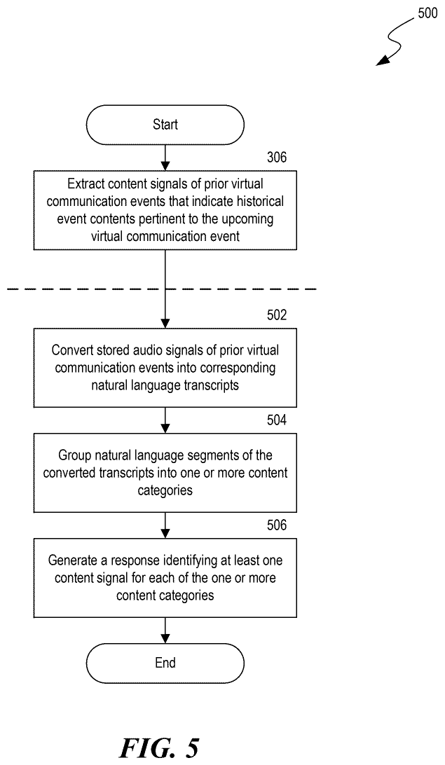

FIG. 5 is a flow diagram that illustrates an example process 500 for extracting content signals of virtual communication events in accordance with some implementations of the disclosed technology. The process 500 can be performed by a system (e.g., content informatics platform 200) configured to identify pertinent content information based on audio signals (e.g., recorded teleconference audio logs) of one or more virtual communication events. In one example, the system includes at least one hardware processor and at least one non-transitory memory storing instructions, which, when executed by the at least one hardware processor, cause the system to perform the process 500. In another example, the system includes a non-transitory, computer-readable storage medium comprising instructions recorded thereon, which, when executed by at least one data processor, cause the system to perform the process 500. In some implementations, the platform 200 can be configured to perform the process 500 alongside the example process 300 of FIG. 3. As shown in FIG. 5, the platform 200 can perform the process 500 following block 306 (or alternatively other available processing steps) of example process 300.

At block 502, the system can convert stored audio signals of prior virtual communication events into alphanumeric signals. For example, the platform 200 can convert recorded audio logs (e.g., stored conversion recordings) associated with prior virtual communication events (e.g., corresponding to an upcoming event) into text-based transcripts. In some implementations, the platform 200 can further decompose the converted text transcripts into a plurality of natural language segments, each associated with a timestamp (e.g., corresponding datetime in the audio recording log) and a user identifier (e.g., identify of speaker in audio recording log). In some implementations, the platform 200 can be configured to generate a full transcript and the natural language segments simultaneously (e.g., in parallel).

At block 504, the system can group the natural language segments of the converted alphanumeric signals into one or more content categories (e.g., discuss topics and/or key conversation points). For example, the platform 200 can use a statistical inference model (e.g., a machine learning model) to group the plurality of natural language segments into categorical groups of similar content and/or event information.

At block 506, the system can extract content signals for each categorical grouping of natural language transcript segments. For example, the platform 200 can cause a generative machine learning model (e.g., a large language model) to generate a response identifying at least one content signal (e.g., discussion summaries, key points and/or objectives of conversation, a chronological timeline, and/or the like) for each of the one or more content categories, such that each content signal indicates historical event information pertinent to the at least one upcoming virtual communication event.

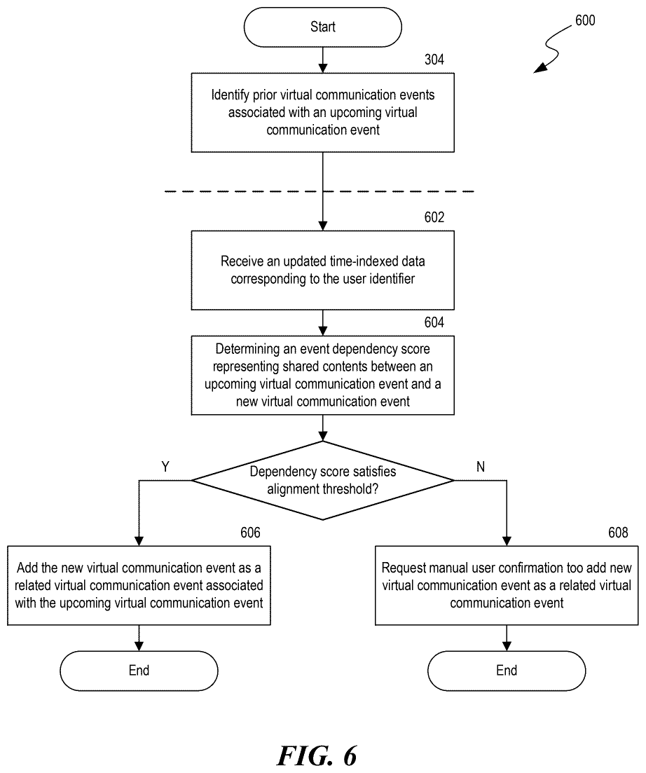

FIG. 6 is a flow diagram that illustrates an example process 600 for mapping virtual communication events in accordance with some implementations of the disclosed technology. The process 600 can be performed by a system (e.g., content informatics platform 200) configured to link virtual communication events (e.g., online teleconference meetings) that demonstrate content dependencies. In one example, the system includes at least one hardware processor and at least one non-transitory memory storing instructions, which, when executed by the at least one hardware processor, cause the system to perform the process 600. In another example, the system includes a non-transitory, computer-readable storage medium comprising instructions recorded thereon, which, when executed by at least one data processor, cause the system to perform the process 600. In some implementations, the platform 200 can be configured to perform the process 600 alongside the example process 300 of FIG. 3. As shown in FIG. 6, the platform 200 can perform the process 600 following block 304 (or alternatively other available processing steps) of example process 300.

At block 602, the system can receive an updated time-indexed data (e.g., an updated calendar schedule information) corresponding to the user identifier. For example, the platform 200 can receive (e.g., via a user interface) a new uploaded, recorded, or scheduled calendar information that includes one or more new virtual communication events (e.g., online teleconference meetings) accessible to participant users associated with the user identifier. In some implementations, the platform 200 can also receive separate event feature sets for each new virtual communication event, such that the event features indicate contextual metadata associated with the new virtual communication event.

At block 604, the system can determine an approximate event dependency score that represents content similarities and/or content correlation strength between at least one upcoming virtual communication event and a new virtual communication event (e.g., of the updated time-indexed data). For example, the platform 200 can compare the event feature sets corresponding to the upcoming event and the new event to determine the approximate event dependency score, or classification.

At block 606, the system can add new virtual communication events to the identified collection of prior virtual communication events associated with upcoming virtual communication events. As an illustrative example, the platform 200 can add a newly scheduled calendar event to a list of previous calendar events, or as a related calendar event, associated with an upcoming calendar event in response to the event dependency score between the new event and the upcoming event (e.g., or between the new event and the prior events) satisfying an alignment threshold. At block 608, the platform 200 can be configured to request manual confirmation from an end user (e.g., via the user interface) that new events found in the updated time-indexed data should be associated with the upcoming event (e.g., or any one of the prior events) in response to the event dependent score failing to satisfy the alignment threshold.

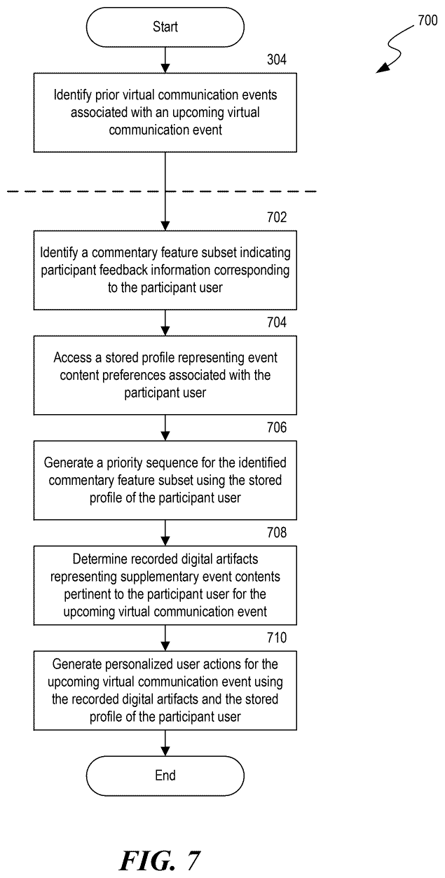

FIG. 7 is a flow diagram that illustrates an example process 700 for generating personalized recommendations in accordance with some implementations of the disclosed technology. The process 700 can be performed by a system (e.g., content informatics platform 200) configured to generate personalized actionable recommendations for a virtual communication event (e.g., an upcoming teleconference meeting) based on monitored user preferences and historical interactions in prior virtual communication events. In one example, the system includes at least one hardware processor and at least one non-transitory memory storing instructions, which, when executed by the at least one hardware processor, cause the system to perform the process 700. In another example, the system includes a non-transitory, computer-readable storage medium comprising instructions recorded thereon, which, when executed by at least one data processor, cause the system to perform the process 700. In some implementations, the platform 200 can be configured to perform the process 700 alongside the example process 300 of FIG. 3. As shown in FIG. 7, the platform 200 can perform the process 700 following block 304 (or alternatively other available processing steps) of example process 300.

The platform 200 can be configured to generate personalized user action recommendations for upcoming virtual communication events (e.g., online teleconference meetings) based on historical user interactions and observed content preferences associated with an individual user identifier. For example, at block 702, the system can identify commentary features indicating participant feedback data (e.g., stated opinions, questions, concerns, and/or the like) associated with a participant user. In one example, the platform 200 can use the user identifier to selectively identify a subset of commentary features originating from participant users associated with the user identifier (e.g., commentary information generated by the participant user).

At block 704, the system can access (e.g., from the computing database 204) a stored profile indicating virtual communication event content preferences for the participant user associated with the user identifier. For example, the system can access a stored profile that comprises one or more recorded user interactions (e.g., review and/or usage of historical digital artifacts) of the participant user during prior virtual communication events. In some implementations, the user profile can also include contextual metadata representing a predetermined identity (e.g., a participant role), a prior expressed sentiment, a meeting intent, and/or the like associated with the participant user.

At block 706, the system can use the accessed profile of the participant user to generate a priority sequence for the identified commentary feature subset of the participant user. For example, the platform 200 can assign each commentary feature of the participant user a priority score indicating relative significance and/or urgency for the feature to be addressed during the upcoming virtual communications event.

At block 708, the system can determine recorded digital artifacts (e.g., from the digital artifacts database 252) that are pertinent to the prioritized commentary features associated with the participant user. For example, the platform 200 can use a statistical inference algorithm (e.g., a machine learning model, a natural language processing algorithm, and/or the like) to identify stored digital artifacts that comprise contents similar to commentary features of the participant user associated with high priority scores.

At block 710, the system can generate a natural language response indicating one or more personalized user actions for the participant user to invoke during the upcoming virtual communications event. For example, the platform 200 can cause a generative machine learning model (e.g., a large language model) to create a set of actionable recommendations based on the identified recorded digital artifacts and the stored profile of the participant user.

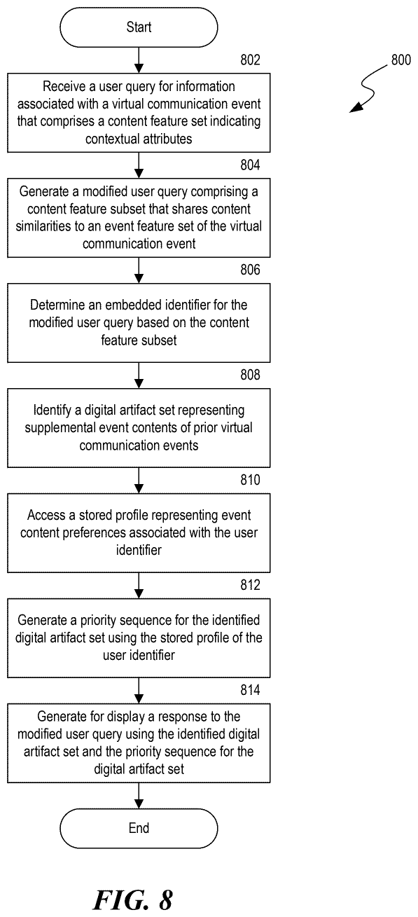

FIG. 8 is a flow diagram that illustrates an example process 800 for generating a query response in accordance with some implementations of the disclosed technology. The process 800 can be performed by a system (e.g., content informatics platform 200) configured to generate responses to user queries for information (e.g., digital artifacts, synthesized data, and/or the like) associated with one or more virtual communications events (e.g., teleconference meetings). In one example, the system includes at least one hardware processor and at least one non-transitory memory storing instructions, which, when executed by the at least one hardware processor, cause the system to perform the process 800. In another example, the system includes a non-transitory, computer-readable storage medium comprising instructions recorded thereon, which, when executed by at least one data processor, cause the system to perform the process 800.

At block 802, the system can receive a user submitted query (e.g., a text-based question and/or request) for information associated with a virtual communication event (e.g., identifying relevant digital artifacts for conversation). For example, the platform 200 can receive (e.g., from a user interface of the user identifier) a user query that comprises a content feature set indicating contextual attributes (e.g., contextual prompt descriptions) indicating required, or preferred, properties of the output response. In some implementations, the platform 200 can receive real-time user queries (e.g., via the user interface) during a real-time virtual communications event (e.g., during an active teleconference meeting).

At block 804, the system can generate a modified user query that comprises a content feature subset that shares content similarities to an event feature set of the virtual communication event. For example, the platform 200 can be configured to compare the contextual attributes of each content feature to the event features of a target virtual communication event. Accordingly, the platform 200 can identify a subset of content features from the original user query that is critical and/or essential to answering the user request (e.g., filtering out unclear and/or irrelevant contextual information from the user query).

At block 806, the system can determine an embedded identifier for the modified user query based on the determined subset of content features. For example, the platform 200 can use a semantic encoder (e.g., a natural language processing algorithm, a machine learning model) to generate a unique quantitative identifier for the subset of content features. In other words, the platform 200 can generate a normalized identity (e.g., a numeric vector) that characterizes the unique contextual attributes associated with the modified user query.

At block 808, the system can identify one or more digital artifacts that represent supplemental event contents of prior virtual communication events. For example, the platform 200 can compare (e.g., via a machine learning algorithm and/or model) the embedded identifier of the modified user query to the embedded identifiers of the contents of the stored digital artifacts (e.g., from the digital artifacts database 250) to determine a content similarity score for each digital artifact. For each digital artifact corresponding to a content similarity score that satisfies a similarity threshold, the platform 200 can assign the digital artifact as pertinent content for responding to the modified user query (e.g., and the original user query).

At block 810, the system can access a stored profile representing event content preferences associated with the user identifier. In some implementations, the platform 200 can also generate a priority sequence for the digital artifacts, such that each digital artifact is assigned a priority level indicating compatibility with the content preferences of the user profile. Accordingly, the platform 200 can be configured to primarily use content information from digital artifacts with high priority scores when generating responses to the user query.

At block 812, the system can generate a response to the modified user query based on the identified set of digital artifacts and the priority sequence for the digital artifacts. For example, the platform 200 can cause a generative machine learning model (e.g., a large language model) to create a natural language response to the modified user query based on content information from the identified digital artifacts. The platform 200 can also configure the generative model to prioritize using content information from digital artifacts that correspond to higher priority scores when generating the response. At block 814, the system can display the generated response to the modified query (e.g., and the original user query) at the user interface associated with the user identifier. An ordinary person skilled in the art will appreciate that any combination of the foregoing steps can be performed iteratively until a satisfactory response is generated for the user query.

In some implementations, the content informatics platform 200 may provide a comprehensive dynamic user interface comprising elements designed to facilitate efficient information management across an organization. These interface components may be utilized to manage meetings, access relevant meeting content, and derive actionable insights from meeting interactions. The various user interface elements may be accessed through various entry points of the platform and may present information in formats tailored to specific use cases and user preferences.

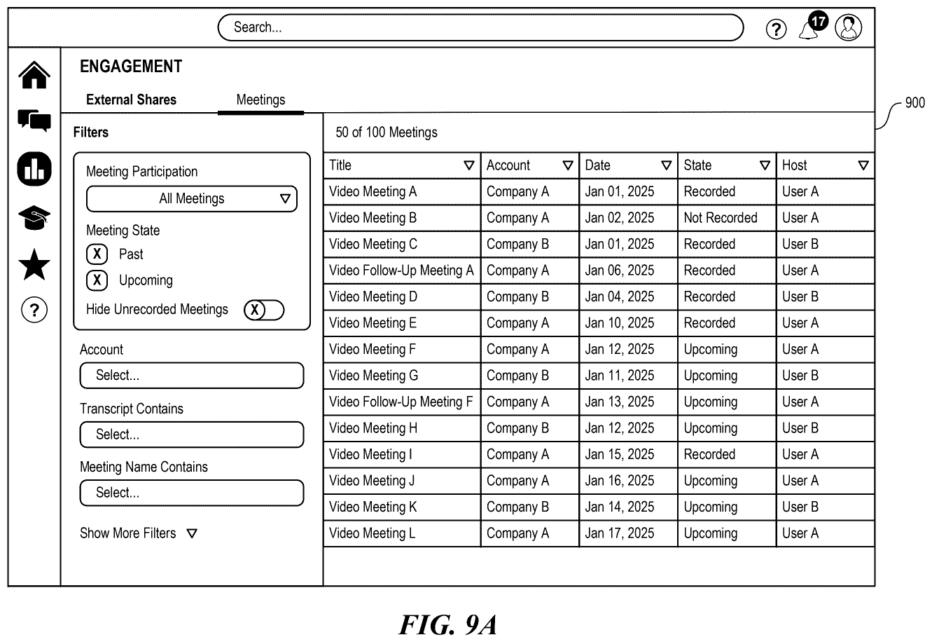

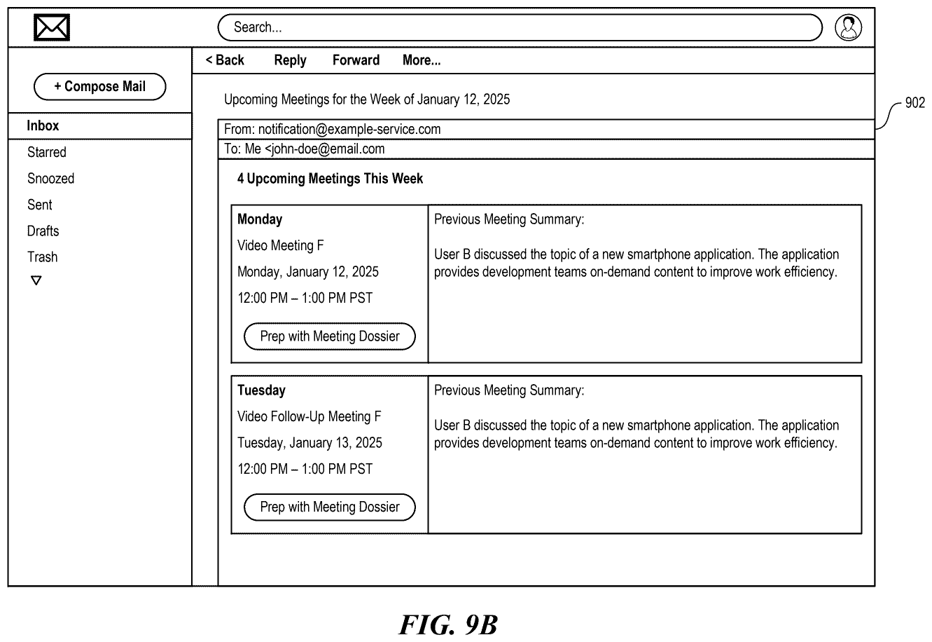

FIGS. 9A-9B illustrate example access methods for an informatics interface in accordance with some implementations of the present technology. As illustrated in FIG. 9A, the platform comprises an informatics interface 900. In some implementations, the informatics interface 900 serves as a centralized hub, presenting users with a comprehensive view of both past and upcoming meetings extracted from, for example, a linked calendar or e-mail application. In some implementations, the meeting repository interface may display key information for each meeting, such as the title, date and time, attendees, status (e.g., upcoming, completed, cancelled), host, and associated project or client, among others. In some implementations, the informatics interface 900 is configured to allow users to quickly assess their meeting schedule and prioritize preparation. As shown in FIG. 9A, the informatics interface 900 may include robust filtering and sorting options, such that users may quickly locate specific meetings based on a wide range of criteria. For example, users may filter meetings by date range, attendees, associated projects, or meeting types (e.g., client calls, internal reviews, project kickoffs), among others. Sorting options enable users to arrange meetings chronologically, alphabetically by title, or by other relevant criteria such as priority or duration, among others.

Each meeting entry in the informatics interface 900 may be selectable, enabling users to access a more detailed meeting interface. Navigation between the high-level informatics interface 900 and detailed meeting information allows for efficient information and meeting preparation. The informatics interface 900 may also comprise a search function, facilitating the discovery of meetings based on keywords, discussed topics, or other relevant metadata, among other. The search capability may leverage natural language processing to understand user queries and return the most relevant results.

In addition to the informatics interface 900, the content informatics platform 200 may comprise alternative interfaces to access high-level meeting information and schedules, as depicted in FIG. 9B. This figure illustrates an e-mail digest interface 902, which provides a summary of scheduled meetings via an electronically transmitted message via, for example, e-mail. This email digest interface 902 serves as a convenient tool for users to review their upcoming commitments without needing to access the content informatics platform 200. The email digest interface 902 may be customizable, allowing users to set preferences for how frequently they receive these summaries and what types of meeting information are included. The email digest interface 902 may include a list of upcoming meetings for a specific time interval, such as the day ahead and/or the upcoming week. For each meeting, the email digest interface 902 may display key details including the time, attendees, location or virtual meeting link, and brief summaries or agenda items, among others.

In some implementations, the e-mail digest interface 902 may utilize color coding or icons to differentiate between different types of meetings (e.g., internal vs. external, decision-making vs. informational) or to highlight high-priority events that require immediate attention or preparation. The e-mail digest interface may comprise direct links to access a full meeting interface for each listed meeting. These links allow users to seamlessly transition from the digest summary to the comprehensive meeting dossier with a single click.

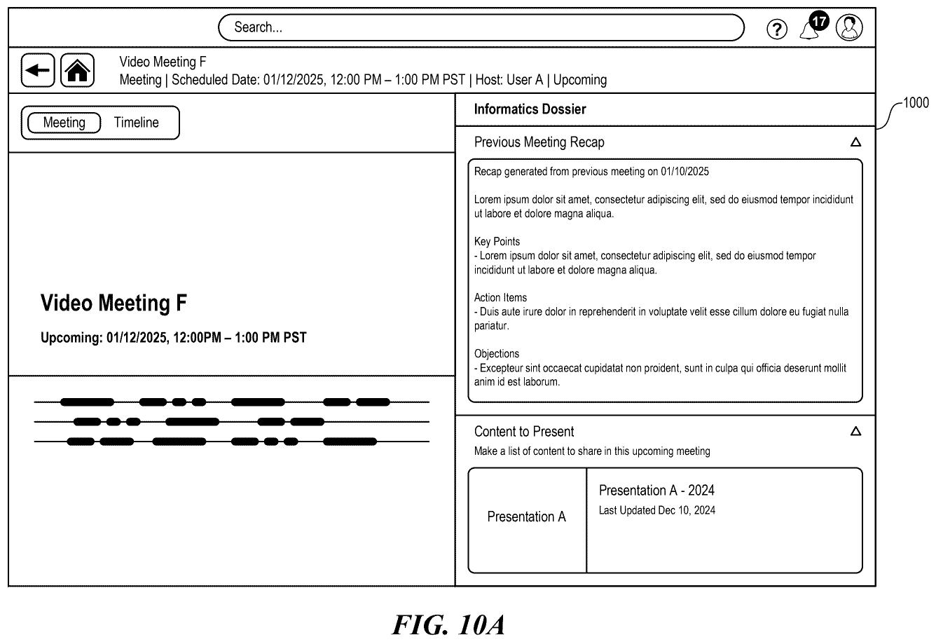

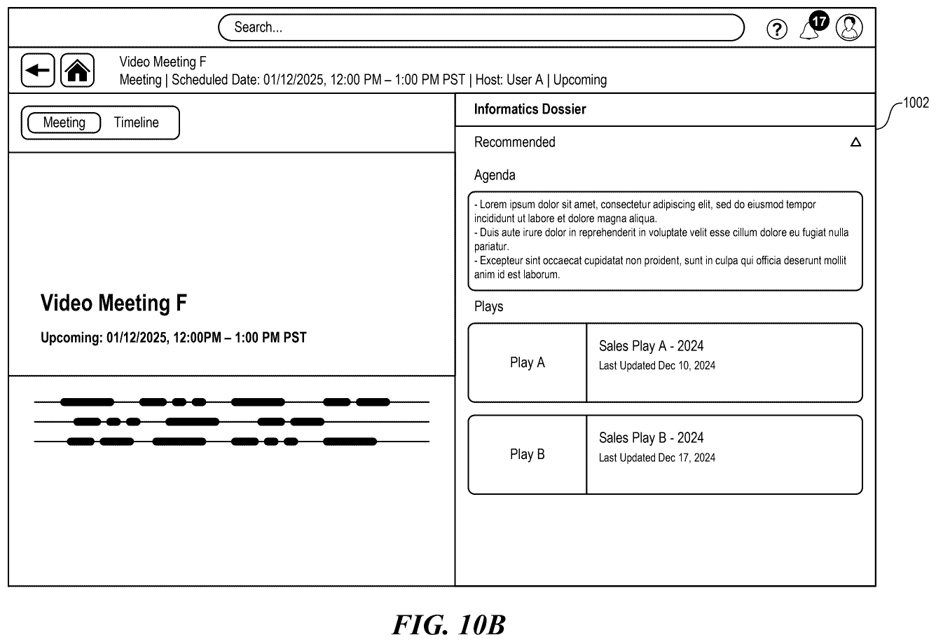

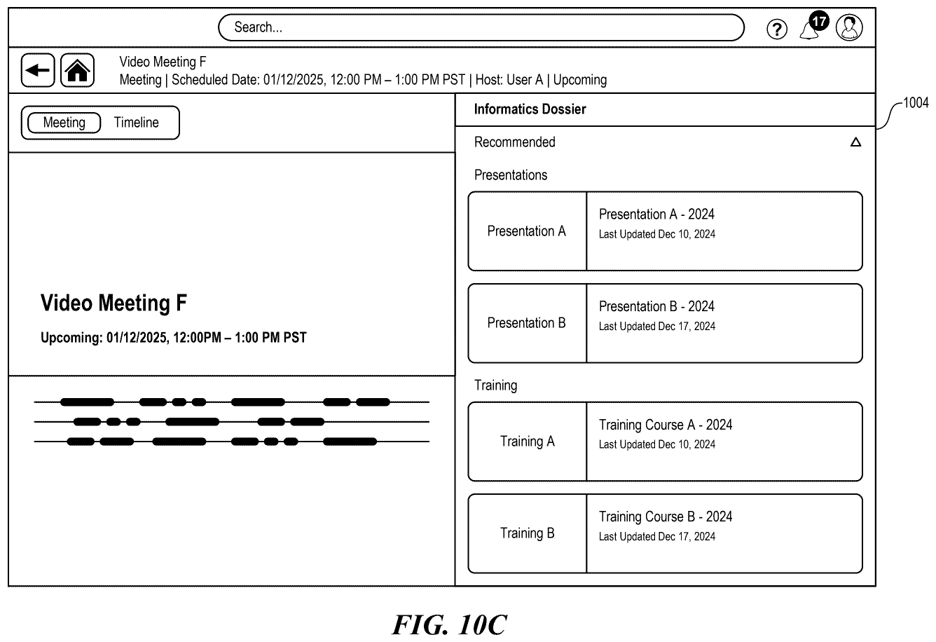

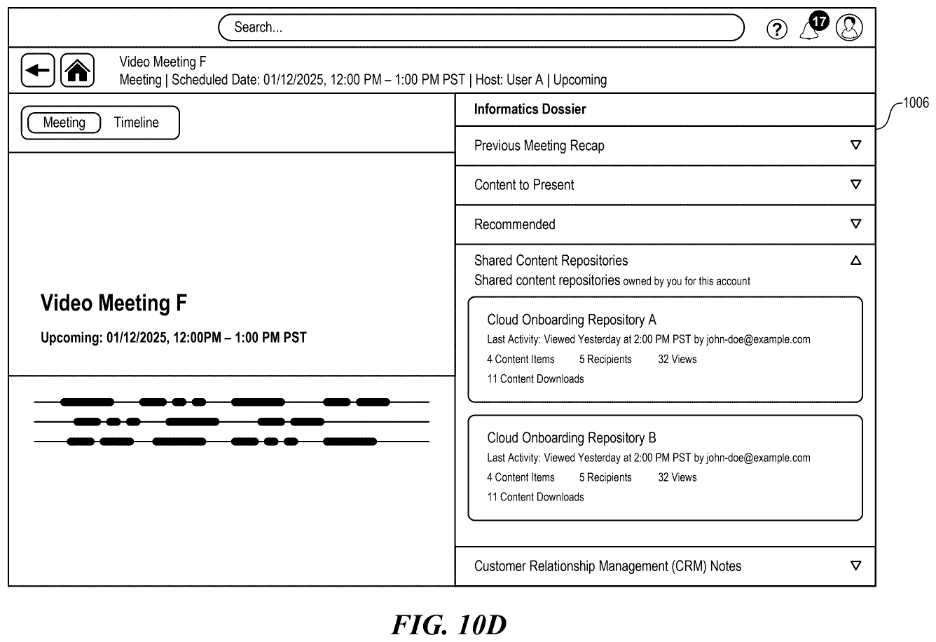

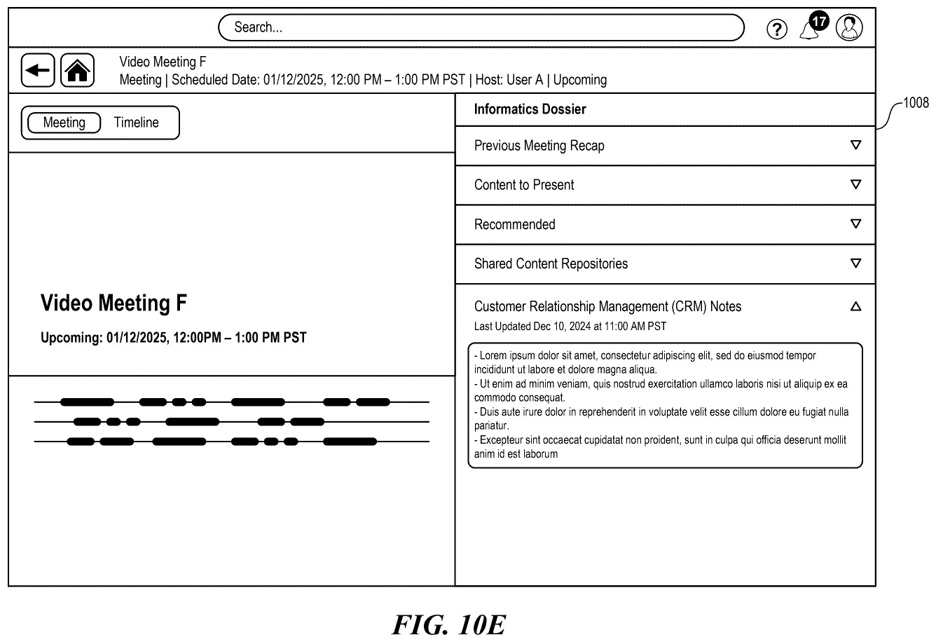

FIGS. 10A-10E illustrate an example informatics interface in accordance with some implementations of the present technology. FIG. 10A illustrates an informatics interface 1000 according to some implementations herein. The informatics interface 1000 comprises multiple sections designed to provide specific types of information and functionality to support effective meeting preparation and follow-up. FIG. 10A illustrates at least first and second portions of a dossier for an upcoming meeting. The first portion of the dossier comprises a recap of a previous related meeting. In some implementations, recap serves as a context-setting tool, facilitating continuity between related meetings and helping participants refresh their memory of previous discussions. The recap may comprise several elements, including a summary of key points discussed in the previous meeting, decisions made, or conclusions reached, action items assigned during the previous meeting, and unresolved issues or topics that require follow-up, among others.

This recap may be presented in various formats to suit based on user preferences and meeting types. For more formal or structured meetings, the recap may take the form of a concise, bullet-point list that allows for quick scanning and information retrieval. For meetings with more narrative flow or complex discussions, the recap may be presented as a more detailed summary. The recap may also include interactive elements. For example, the recap might feature expandable sections that describe specific topics in more detail. The recap may also include links to more comprehensive information about the previous meeting, such as full transcripts, recordings, or related documents, among others.

The second portion of the dossier shown in FIG. 10A focuses on content preparation for the upcoming meeting. This section includes links to content that the user may want to present or reference during the meeting. The content links may be organized as a list or grid of selectable items, each representing a piece of content relevant to the meeting agenda or topics. For each content item, the interface may display several pieces of information to help users quickly assess relevance. This information may include a thumbnail or icon representing the content type (e.g., document, presentation, image, video), the title of the content item, a brief description or preview of the content, the date the content was last modified or shared, tags or categories associated with the content, and usage statistics, such as how often the content has been presented in similar meetings, among others.

In some implementations, the links may be selectable to preview content directly within the informatics interface 1000. The interface may also provide options to open the content in its native application for editing or to add it to a presentation queue for the upcoming meeting. The content preparation section may leverage AI/ML capabilities to suggest the most relevant content based on the meeting agenda, participants, and historical data from similar meetings. For example, the system may analyze patterns in content usage across the organization to recommend materials that have been particularly effective in similar contexts.

FIG. 10B illustrates another example informatics interface 1002 according to some implementations herein, including a third portion of the dossier, which comprises various recommendations automatically generated based on analysis of one or more previous meetings. The recommendations section may provide users with AI-driven insights and may include several components, such as a suggested agenda for the upcoming meeting, strategies for approaching the meeting, and content items relevant for the user to review or share, among others. In some implementations, the suggested agenda may be presented as an ordered list of topics for discussion points, with each agenda item including an estimated time allocation. The suggested agenda may be based on analysis of previous meeting patterns, unresolved items from past meetings, and the stated objectives of the current meeting. To maintain flexibility, in some implementations, the agenda may be editable, allowing users to add, remove, or reorder items as needed.

A strategies section of the informatics interface 1002 may comprise AI/ML generated tactical advice based on the meeting context and participants, including conversation starters, negotiation tactics, or ways to address potential objections. The strategies may be tailored based on the user's role in the meeting (e.g., host, presenter, participant) and may draw on best practices identified from successful meetings across the organization. Each recommended content item may include a brief explanation of why it's relevant to the upcoming meeting, helping users understand the context and potential value of the suggested material. In some implementations, the informatics interface 1002 may be configured such that users may add these recommended items to their presentation list or meeting materials.

FIG. 10C illustrates another example informatics interface 1004. The informatics interface 1004 may comprise a recommendations section of the dossier, which may further include recommended training courses or modules for the user to complete prior to the meeting to address any potential gaps in knowledge before the meeting takes place. The training recommendations area may comprise a list of relevant courses or training modules, brief descriptions of each recommended training item, estimated time to complete each training, an indication of the relevance or importance of each training item to the upcoming meeting, and links to directly access the recommended training content, among others. The training recommendations may be prioritized based on their relevance to the meeting topics, the user's role, or identified knowledge gaps. In some implementations, the interface 1004 may also display the user's progress on any ongoing training courses related to the meeting subject matter.

FIG. 10D illustrates another example informatics interface 1006, comprising a fourth portion of the dossier comprising links to digital meeting rooms. In some implementations, digital rooms serve as shared repositories for information related to the meeting or series of meetings. In some implementations, the digital room section of the interface may display a list of available digital rooms associated with the meeting or project, brief descriptions or purposes for each digital room, the number of participants or collaborators in each room, recent activity indicators for each room, and/or options to create new digital rooms or manage existing ones. In some implementations, users may be able to select a digital room link to access the full digital room interface, where the users can view and interact with shared content, collaborate with other participants, and manage meeting-related resources.

FIG. 10E illustrates another example informatics interface 1008, comprising a fifth portion of the dossier, which populates notes from a linked customer relationship management (CRM) object into the dossier. In some implementations, the CRM integration section may include customer or account information relevant to the meeting, recent interactions or communications with the meeting participants, sales pipeline status or opportunity details, customer-specific notes or insights from the CRM system, and action items or follow-ups logged in the CRM related to the meeting participants or topics. The section may be dynamically updated to reflect the latest information from the CRM system.

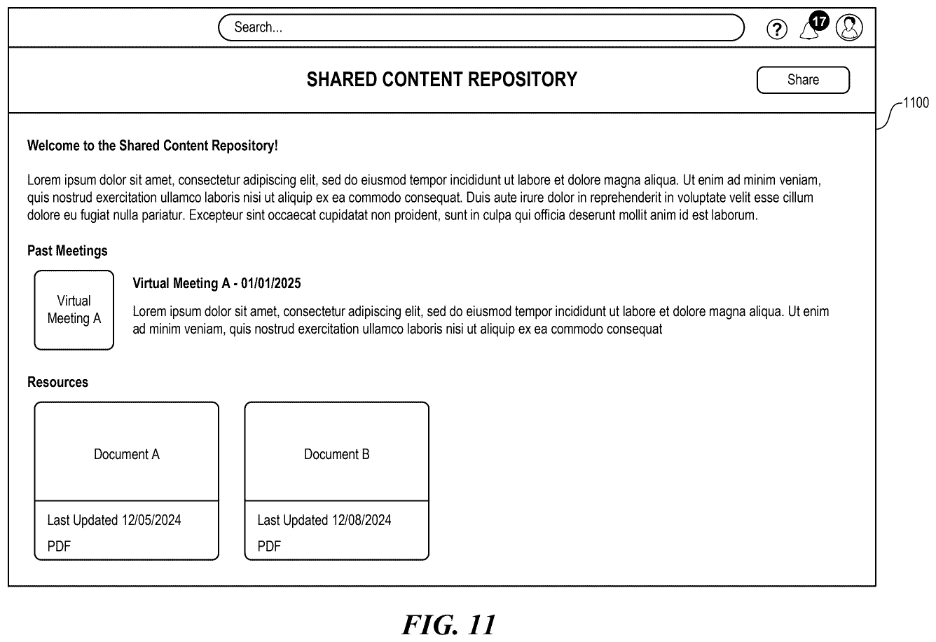

FIG. 11 illustrates an example digital room interface 1100 in accordance with some implementations of the present technology. The digital room interface 1100 serves as a shared content repository associated with a meeting or series of meetings. The digital room interface may include several components designed to facilitate collaboration and information sharing among meeting participants, including a section for past meeting links, which may present a chronological list or timeline of past meetings related to the current project or interaction. Each past meeting link may include the date, attendees, and a brief summary, among others. In some implementations, selecting a past meeting link may provide access to recordings, transcripts, or detailed summaries. The digital room interface may also include a resources section, which may include a collection of content items that were used in previous meetings. This may include documents, presentations, images, videos, or other relevant files. The resources may be organized by type, date, or relevance to specific meeting topics.

An upcoming meetings display may also be included in digital room interface 1100. The display of upcoming meetings may be presented as a list or calendar view of future scheduled meetings related to the current interaction. Each upcoming meeting entry may include date, time, attendees, and a brief agenda. Options to add new meetings or modify existing ones may be included in the digital room interface 1100, allowing for flexible scheduling and planning within the context of the ongoing project or relationship. The digital room interface 1100 may also include a section for action items or next steps. This section may be implemented as a task list or board showing action items identified during meetings. Each action item may include a description, assignee, due date, and status. Users may be able to update the status of action items directly from this interface, providing real-time visibility into progress and accountability for follow-through on meeting outcomes. In some implementations, the digital room interface 1100 may include content addition tools, including buttons or drag-and-drop areas for users to add new content to the digital room, upload files, create new documents, or link to external resources. In some implementations, collaboration features may be integrated throughout the digital room interface 1100, such as comment threads or discussion areas associated with specific content items, real-time editing capabilities for shared documents, and notification settings to alert users of new additions or changes to the digital room.

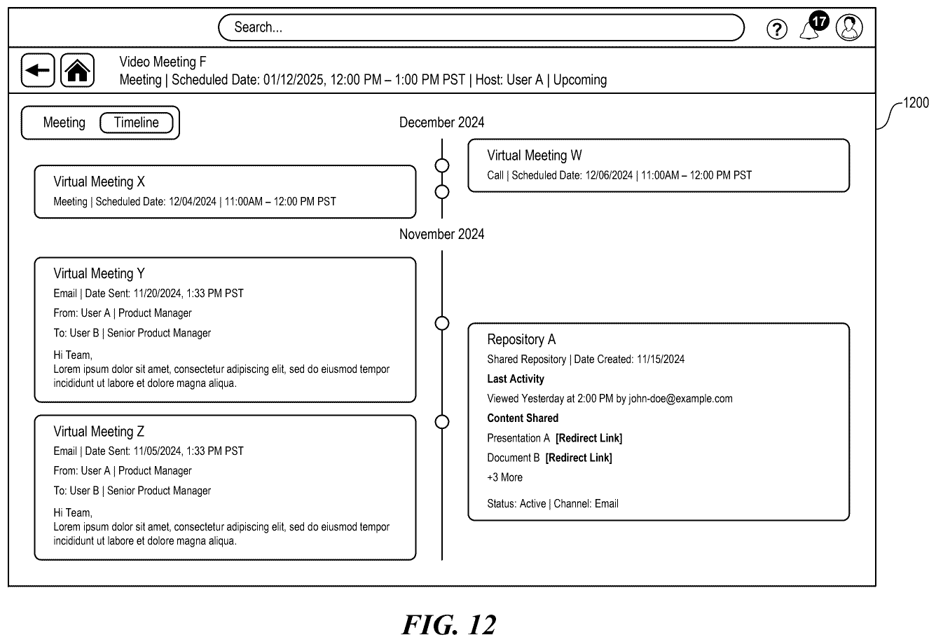

FIG. 12 illustrates an example timeline window 1200 within the meeting interface. The timeline window 1200 may provide a visual history of past and upcoming meetings that are related to one another, such as meetings associated with the same sales opportunity or project. The timeline window 1200 may include a chronological display, showing the progression of meetings over time with demarcation between past and future events. Each meeting along the timeline may be represented by an identifier, such as an icon, dot, or bar, providing a visual reference for the frequency and distribution of meetings over time. For past meetings, the timeline may display brief summaries adjacent to each meeting identifier. In some implementations, these summaries may be generated by an LLM based on analysis of the meeting transcript. In some implementations, users may be able to interact with the timeline by selecting individual meeting identifiers. Selection may provide access to more detailed information about each meeting, including recordings, full dossiers, related content items, and topics discussed. In some implementations, the timeline window 1200 may also visually distinguish between different types of meetings or interactions. For example, the timeline may utilize use different colors or shapes to represent in-person meetings, video calls, phone conversations, or email exchanges. In some implementations, the timeline window 1200 may be interactive, allowing users to filter or sort meetings based on various criteria such as attendees, topics discussed, or outcomes achieved. For example, a sales representative may filter the timeline to show only meetings where pricing was discussed, or a project manager might focus on meetings with key decision-makers.

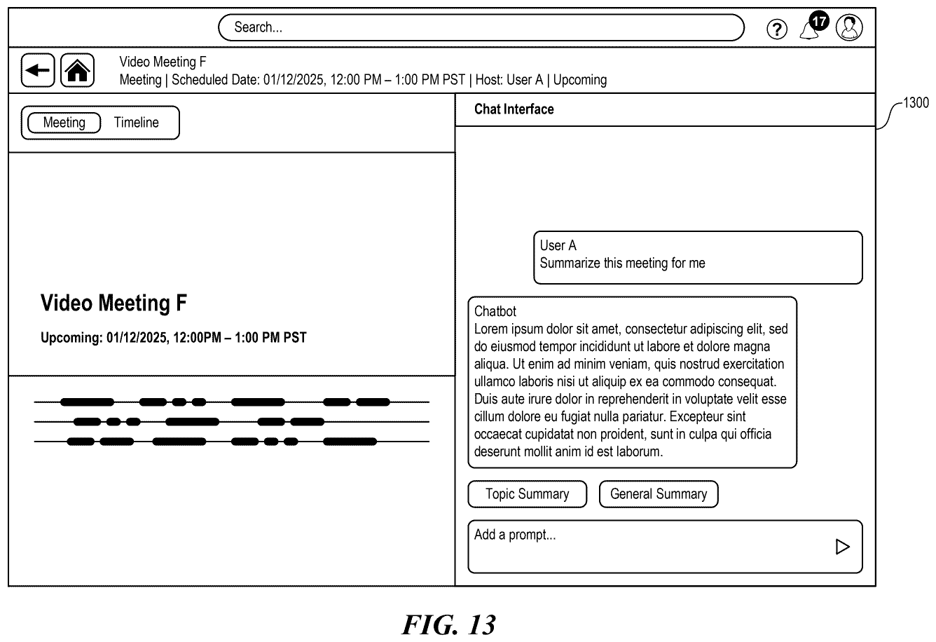

FIG. 13 illustrates an example chat interface in accordance with some implementations of the present technology. The content informatics platform 200 can include a chat interface 1300 within the meeting interface, as shown in FIG. 13. The chat interface 1300 may feature a chat window that enables users to converse with an AI/ML chatbot powered by, for example, an LLM. Users may leverage this chat interface to ask questions about various aspects of their meetings and related content. For example, a user may inquire about specific details from previous meetings, seek clarification on recommended content, or ask for insights about attendees or topics. The chatbot, drawing on the comprehensive data available within the content informatics platform 200, can provide quick, contextually relevant responses to these queries. In some implementations, the chat interface 1300 may be configured to understand and respond to natural language inputs. In some implementations, the chat interface 1300 may not require a user to type a query. Instead, the chatbot may receive an autogenerated transcription of a portion of a conversation. For example, if a user asks a question during a live meeting, the chatbot may receive a transcription of the question, identify content related to the question, and generate a prompt to the large language model using the transcribed question and the identified content.

### Example Machine Learning Architecture

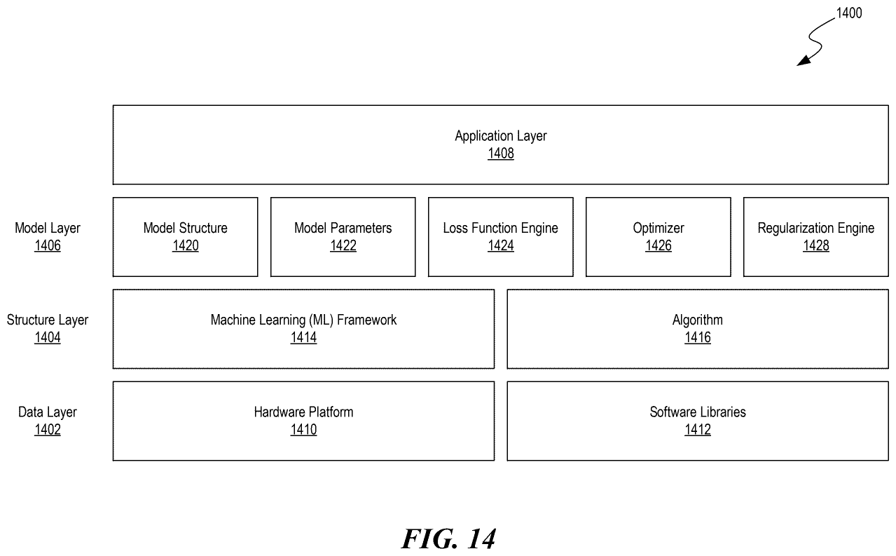

FIG. 14 illustrates a layered architecture of an artificial intelligence (AI) system 1400 that can implement the ML models of the content informatics platform 200 of FIG. 2, in accordance with some implementations of the present technology. Example ML models can include the models executed by the models stored in the machine learning models database. Accordingly, the machine learning models database can include one or more components of the AI system 1400.

As shown, the AI system 1400 can include a set of layers, which conceptually organize elements within an example network topology for the AI system's architecture to implement a particular AI model. Generally, an AI model is a computer-executable program implemented by the AI system 1400 that analyses data to make predictions. Information can pass through each layer of the AI system 1400 to generate outputs for the AI model. The layers can include a data layer 1402, a structure layer 1404, a model layer 1406, and an application layer 1408. The algorithm 1416 of the structure layer 1404 and the model structure 1420 and model parameters 1422 of the model layer 1406 together form an example AI model. The optimizer 1426, loss function engine 1424, and regularization engine 1428 work to refine and optimize the AI model, and the data layer 1402 provides resources and support for application of the AI model by the application layer 1408.

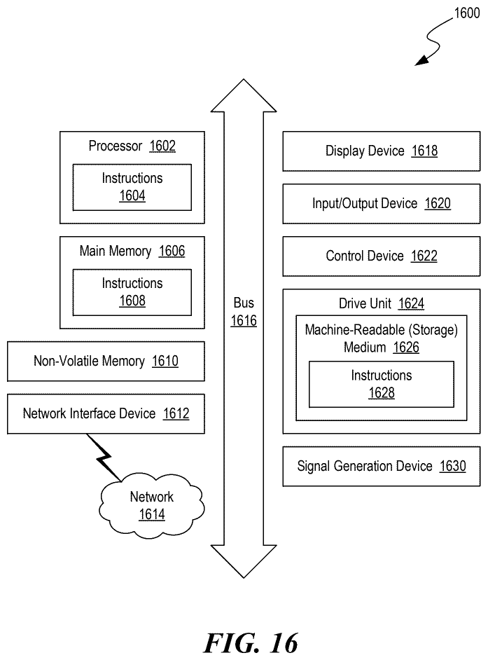

The data layer 1402 acts as the foundation of the AI system 1400 by preparing data for the AI model. As shown, the data layer 1402 can include two sub-layers: a hardware platform 1410 and one or more software libraries 1412. The hardware platform 1410 can be designed to perform operations for the AI model and include computing resources for storage, memory, logic, and networking, such as the resources described in relation to FIGS. 1 and 16. The hardware platform 1410 can process amounts of data using one or more servers. The servers can perform backend operations such as matrix calculations, parallel calculations, machine learning (ML) training, and the like. Examples of servers used by the hardware platform 1410 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors, such as application specific integrated circuits (ASIC). GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 1410 can include computing resources, (e.g., servers, memory, etc.) offered by a cloud services provider. The hardware platform 1410 can also include computer memory for storing data about the AI model, application of the AI model, and training data for the AI model. The computer memory can be a form of random-access memory (RAM), such as dynamic RAM, static RAM, and non-volatile RAM.

The software libraries 1412 can be thought of suites of data and programming code, including executables, used to control the computing resources of the hardware platform 1410. The programming code can include low-level primitives (e.g., fundamental language elements) that form the foundation of one or more low-level programming languages, such that servers of the hardware platform 1410 can use the low-level primitives to carry out specific operations. The low-level programming languages do not require much, if any, abstraction from a computing resource's instruction set architecture, allowing them to run quickly with a small memory footprint. Examples of software libraries 1412 that can be included in the AI system 1400 include INTEL Math Kernel Library, NVIDIA cuDNN, EIGEN, and OpenBLAS.

The structure layer 1404 can include an ML framework 1414 and an algorithm 1416. The ML framework 1414 can be thought of as an interface, library, or tool that allows users to build and deploy the AI model. The ML framework 1414 can include an open-source library, an application programming interface (API), a gradient-boosting library, an ensemble method, and/or a deep learning toolkit that work with the layers of the AI system facilitate development of the AI model. For example, the ML framework 1414 can distribute processes for application or training of the AI model across multiple resources in the hardware platform 1410. The ML framework 1414 can also include a set of pre-built components that have the functionality to implement and train the AI model and allow users to use pre-built functions and classes to construct and train the AI model. Thus, the ML framework 1414 can be used to facilitate data engineering, development, hyperparameter tuning, testing, and training for the AI model. Examples of ML frameworks 1414 that can be used in the AI system 1400 include TENSORFLOW, PYTORCH, SCIKIT-LEARN, KERAS, LightGBM, RANDOM FOREST, and AMAZON WEB SERVICES.

The algorithm 1416 can be an organized set of computer-executable operations used to generate output data from a set of input data and can be described using pseudocode. The algorithm 1416 can include complex code that allows the computing resources to learn from new input data and create new/modified outputs based on what was learned. In some implementations, the algorithm 1416 can build the AI model through being trained while running computing resources of the hardware platform 1410. This training allows the algorithm 1416 to make predictions or decisions without being explicitly programmed to do so. Once trained, the algorithm 1416 can run at the computing resources as part of the AI model to make predictions or decisions, improve computing resource performance, or perform tasks. The algorithm 1416 can be trained using supervised learning, unsupervised learning, semi-supervised learning, and/or reinforcement learning.

Using supervised learning, the algorithm 1416 can be trained to learn patterns (e.g., map input data to output data) based on labeled training data. The training data may be labeled by an external user or operator. For instance, a user may collect a set of training data, such as by capturing data from sensors, images from a camera, outputs from a model, and the like. The user may label the training data based on one or more classes and trains the AI model by inputting the training data to the algorithm 1416. The algorithm determines how to label the new data based on the labeled training data. The user can facilitate collection, labeling, and/or input via the ML framework 1414. In some instances, the user may convert the training data to a set of feature vectors for input to the algorithm 1416. Once trained, the user can test the algorithm 1416 on new data to determine if the algorithm 1416 is predicting accurate labels for the new data. For example, the user can use cross-validation methods to test the accuracy of the algorithm 1416 and retrain the algorithm 1416 on new training data if the results of the cross-validation are below an accuracy threshold.

Supervised learning can involve classification and/or regression. Classification techniques involve teaching the algorithm 1416 to identify a category of new observations based on training data and are used when input data for the algorithm 1416 is discrete. Said differently, when learning through classification techniques, the algorithm 1416 receives training data labeled with categories (e.g., classes) and determines how features observed in the training data (e.g., various claim elements, policy identifiers, tokens extracted from unstructured data) relate to the categories (e.g., risk propensity categories, claim leakage propensity categories, complaint propensity categories). Once trained, the algorithm 1416 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 1416 is continuous. Regression techniques can be used to train the algorithm 1416 to predict or forecast relationships between variables. To train the algorithm 1416 using regression techniques, a user can select a regression method for estimating the parameters of the model. The user collects and labels training data that is input to the algorithm 1416 such that the algorithm 1416 is trained to understand the relationship between data features and the dependent variable(s). Once trained, the algorithm 1416 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for machine-learning based pre-processing operations.

Under unsupervised learning, the algorithm 1416 learns patterns from unlabeled training data. In particular, the algorithm 1416 is trained to learn hidden patterns and insights of input data, which can be used for data exploration or for generating new data. Here, the algorithm 1416 does not have a predefined output, unlike the labels output when the algorithm 1416 is trained using supervised learning. Said another way, unsupervised learning is used to train the algorithm 1416 to find an underlying structure of a set of data, group the data according to similarities, and represent that set of data in a compressed format.

A few techniques can be used in supervised learning; for example, clustering, anomaly detection, and techniques for learning latent variable models. Clustering techniques involve grouping data into different clusters that include similar data, such that other clusters contain dissimilar data. For example, during clustering, data with possible similarities remain in a group that has less or no similarities to another group. Examples of clustering techniques density-based methods, hierarchical based methods, partitioning methods, and grid-based methods. In one example, the algorithm 1416 may be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 1416 may be trained to be an Isolation Forest, local outlier factor (LOF) algorithm, or K-nearest neighbor (k-NN) algorithm. Latent variable techniques involve relating observable variables to a set of latent variables. These techniques assume that the observable variables are the result of an individual's position on the latent variables and that the observable variables have nothing in common after controlling for the latent variables. Examples of latent variable techniques that may be used by the algorithm 1416 include factor analysis, item response theory, latent profile analysis, and latent class analysis.

The model layer 1406 implements the AI model using data from the data layer and the algorithm 1416 and ML framework 1414 from the structure layer 1404, thus enabling decision-making capabilities of the AI system 1400. The model layer 1406 includes a model structure 1420, model parameters 1422, a loss function engine 1424, an optimizer 1426, and a regularization engine 1428.

The model structure 1420 describes the architecture of the AI model of the AI system 1400. The model structure 1420 defines the complexity of the pattern/relationship that the AI model expresses. Examples of structures that can be used as the model structure 1420 include decision trees, support vector machines, regression analyses, Bayesian networks, Gaussian processes, genetic algorithms, and artificial neural networks (or, simply, neural networks). The model structure 1420 can include a number of structure layers, a number of nodes (or neurons) at each structure layer, and activation functions of each node. Each node's activation function defines how to node converts data received to data output. The structure layers may include an input layer of nodes that receive input data, an output layer of nodes that produce output data. The model structure 1420 may include one or more hidden layers of nodes between the input and output layers. The model structure 1420 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 1422 represent the relationships learned during training and can be used to make predictions and decisions based on input data. The model parameters 1422 can weight and bias the nodes and connections of the model structure 1420. For instance, when the model structure 1420 is a neural network, the model parameters 1422 can weight and bias the nodes in each layer of the neural networks, such that the weights determine the strength of the nodes and the biases determine the thresholds for the activation functions of each node. The model parameters 1422, in conjunction with the activation functions of the nodes, determine how input data is transformed into desired outputs. The model parameters 1422 can be determined and/or altered during training of the algorithm 1416.

The loss function engine 1424 can determine a loss function, which is a metric used to evaluate the AI model's performance during training. For instance, the loss function engine 1424 can measure the difference between a predicted output of the AI model and the actual output of the AI model and is used to guide optimization of the AI model during training to minimize the loss function. The loss function may be presented via the ML framework 1414, such that a user can determine whether to retrain or otherwise alter the algorithm 1416 if the loss function is over a threshold. In some instances, the algorithm 1416 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 1426 adjusts the model parameters 1422 to minimize the loss function during training of the algorithm 1416. In other words, the optimizer 1426 uses the loss function generated by the loss function engine 1424 as a guide to determine what model parameters lead to the most accurate AI model. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 1426 used may be determined based on the type of model structure 1420 and the size of data and the computing resources available in the data layer 1402.

The regularization engine 1428 executes regularization operations. Regularization is a technique that prevents over-and under-fitting of the AI model. Overfitting occurs when the algorithm 1416 is overly complex and too adapted to the training data, which can result in poor performance of the AI model. Underfitting occurs when the algorithm 1416 is unable to recognize even basic patterns from the training data such that it cannot perform well on training data or on validation data. The optimizer 1426 can apply one or more regularization techniques to fit the algorithm 1416 to the training data properly, which helps constraint the resulting AI model and improves its ability for generalized application. Examples of regularization techniques include lasso (L1) regularization, ridge (L2) regularization, and elastic (L1 and L2 regularization).

The application layer 1408 describes how the AI system 1400 is used to solve problem or perform tasks. In an example implementation, the application layer 1408 can be communicatively coupled (e.g., display application data, receive user input, and/or the like) to an interactable user interface of the content informatics platform 200 of FIG. 2.

### Example Transformer for Machine Learning Models

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification) to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model can model the target behavior to a desired degree of accuracy. Training typically requires the use of a training dataset, which is a set of data that is relevant to the target behavior of the ML model.

As an example, to train an ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus may be created by extracting text from online webpages and/or publicly available social media posts. Training data may be annotated with ground truth labels (e.g., each data entry in the training dataset may be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted to lower the output value in future training iterations. An objective function is a way to quantitatively represent how close the output value is to the target value. An objective function represents a quantity (or one or more quantities) to be optimized (e.g., minimize a loss or maximize a reward) to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (also referred to as update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may be fixed, and the ML model may be deployed to generate output in real-world applications (also referred to as “inference”).

In some examples, a trained ML model may be fine-tuned, meaning that the values of the learned parameters may be adjusted slightly for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

A language model may use a neural network (typically a DNN) to perform natural language processing (NLP) tasks. A language model may be trained to model how words relate to each other in a textual sequence, based on probabilities. A language model may contain hundreds of thousands of learned parameters or in the case of a large language model (LLM) may contain millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

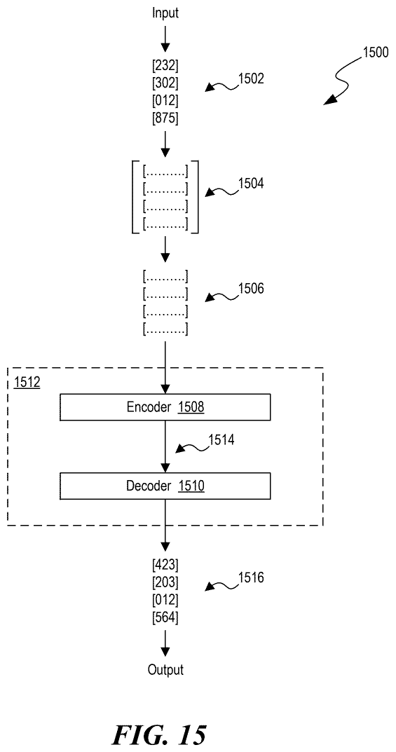

FIG. 15 is a block diagram of an example transformer 1512 that can implement aspects of the present technology. A transformer is a type of neural network architecture that uses self-attention mechanisms to generate predicted output based on input data that has some sequential meaning (i.e., the order of the input data is meaningful, which is the case for most text input). Self-attention is a mechanism that relates different positions of a single sequence to compute a representation of the same sequence. Although transformer-based language models are described herein, it should be understood that the present disclosure may be applicable to any machine learning (ML)-based language model, including language models based on other neural network architectures such as recurrent neural network (RNN)-based language models.

The transformer 1512 includes an encoder 1508 (which can comprise one or more encoder layers/blocks connected in series) and a decoder 1510 (which can comprise one or more decoder layers/blocks connected in series). Generally, the encoder 1508 and the decoder 1510 each include a plurality of neural network layers, at least one of which can be a self-attention layer. The parameters of the neural network layers can be referred to as the parameters of the language model.

The transformer 1512 can be trained to perform certain functions on a natural language input. For example, the functions include summarizing existing content, brainstorming ideas, writing a rough draft, fixing spelling and grammar, and translating content. Summarizing can include extracting key points from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some embodiments, the transformer 1512 is trained to perform certain functions on other input formats than natural language input. For example, the input can include objects, images, audio content, or video content, or a combination thereof.

The transformer 1512 can be trained on a text corpus that is labeled (e.g., annotated to indicate verbs, nouns) or unlabeled. Large language models (LLMs) can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input). FIG. 15 illustrates an example of how the transformer 1512 can process textual input data. Input to a language model (whether transformer-based or otherwise) typically is in the form of natural language that can be parsed into tokens. It should be appreciated that the term “token” in the context of language models and Natural Language Processing (NLP) has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some examples, a token can correspond to a portion of a word.

For example, the word “greater” can be represented by a token for [great] and a second token for [er]. In another example, the text sequence “write a summary” can be parsed into the segments [write], 2, and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 15, a short sequence of tokens 1502 corresponding to the input text is illustrated as input to the transformer 1512. Tokenization of the text sequence into the tokens 1502 can be performed by some pre-processing tokenization module such as, for example, a byte-pair encoding tokenizer (the “pre” referring to the tokenization occurring prior to the processing of the tokenized input by the LLM), which is not shown in FIG. 15 for simplicity. In general, the token sequence that is inputted to the transformer 1512 can be of any length up to a maximum length defined based on the dimensions of the transformer 1512. Each token 1502 in the token sequence is converted into an embedding vector 1506 (also referred to simply as an embedding 1506). An embedding 1506 is a learned numerical representation (such as, for example, a vector) of a token that captures some semantic meaning of the text segment represented by the token 1502. The embedding 1506 represents the text segment corresponding to the token 1502 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 1506 corresponding to the “write” token will be closer to another embedding corresponding to the “jot down” token in the vector space as compared to the distance between the embedding 1506 corresponding to the “write” token and another embedding corresponding to the “summary” token.

The vector space can be defined by the dimensions and values of the embedding vectors. Various techniques can be used to convert a token 1502 to an embedding 1506. For example, another trained ML model can be used to convert the token 1502 into an embedding 1506. In particular, another trained ML model can be used to convert the token 1502 into an embedding 1506 in a way that encodes additional information into the embedding 1506 (e.g., a trained ML model can encode positional information about the position of the token 1502 in the text sequence into the embedding 1506). In some examples, the numerical value of the token 1502 can be used to look up the corresponding embedding in an embedding matrix 1504 (which can be learned during training of the transformer 1512).

The generated embeddings 1506 are input into the encoder 1508. The encoder 1508 serves to encode the embeddings 1506 into feature vectors 1514 that represent the latent features of the embeddings 1506. The encoder 1508 can encode positional information (i.e., information about the sequence of the input) in the feature vectors 1514. The feature vectors 1514 can have very high dimensionality (e.g., on the order of thousands or tens of thousands), with each element in a feature vector 1514 corresponding to a respective feature. The numerical weight of each element in a feature vector 1514 represents the importance of the corresponding feature. The space of all possible feature vectors 1514 that can be generated by the encoder 1508 can be referred to as the latent space or feature space.

Conceptually, the decoder 1510 is designed to map the features represented by the feature vectors 1514 into meaningful output, which can depend on the task that was assigned to the transformer 1512. For example, if the transformer 1512 is used for a translation task, the decoder 1510 can map the feature vectors 1514 into text output in a target language different from the language of the original tokens 1502. Generally, in a generative language model, the decoder 1510 serves to decode the feature vectors 1514 into a sequence of tokens. The decoder 1510 can generate output tokens 1516 one by one. Each output token 1516 can be fed back as input to the decoder 1510 in order to generate the next output token 1516. By feeding back the generated output and applying self-attention, the decoder 1510 is able to generate a sequence of output tokens 1516 that has sequential meaning (e.g., the resulting output text sequence is understandable as a sentence and obeys grammatical rules). The decoder 1510 can generate output tokens 1516 until a special [EOT] token (indicating the end of the text) is generated. The resulting sequence of output tokens 1516 can then be converted to a text sequence in post-processing. For example, each output token 1516 can be an integer number that corresponds to a vocabulary index. By looking up the text segment using the vocabulary index, the text segment corresponding to each output token 1516 can be retrieved, the text segments can be concatenated together, and the final output text sequence can be obtained.

In some examples, the input provided to the transformer 1512 includes instructions to perform a function on an existing text. In some examples, the input provided to the transformer includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text. For example, the input can include the question “What is the weather like in Australia?” and the output can include a description of the weather in Australia.

Although a general transformer architecture for a language model and its theory of operation has been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally, or alternatively, such a remote language model can be accessed via a network such as, for example, the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via its API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally, or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Example Computer System

FIG. 16 is a block diagram that illustrates an example of a computer system 1600 in which at least some operations described herein can be implemented. As shown, the computer system 1600 can include: one or more processors 1602, main memory 1606, non-volatile memory 1610, a network interface device 1612, a video display device 1618, an input/output device 1620, a control device 1622 (e.g., keyboard and pointing device), a drive unit 1624 that includes a machine-readable (storage) medium 1626, and a signal generation device 1630 that are communicatively connected to a bus 1616. The bus 1616 represents one or more physical buses and/or point-to-point connections that are connected by appropriate bridges, adapters, or controllers. Various common components (e.g., cache memory) are omitted from FIG. 16 for brevity. Instead, the computer system 1600 is intended to illustrate a hardware device on which components illustrated or described relative to the examples of the figures and any other components described in this specification can be implemented.

The computer system 1600 can take any suitable physical form. For example, the computing system 1600 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 1600. In some implementations, the computer system 1600 can be an embedded computer system, a system-on-chip (SOC), a single-board computer system (SBC), or a distributed system such as a mesh of computer systems, or it can include one or more cloud components in one or more networks. Where appropriate, one or more computer systems 1600 can perform operations in real time, in near real time, or in batch mode.

The network interface device 1612 enables the computing system 1600 to mediate data in a network 1614 with an entity that is external to the computing system 1600 through any communication protocol supported by the computing system 1600 and the external entity. Examples of the network interface device 1612 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 1606, non-volatile memory 1610, machine-readable medium 1626) can be local, remote, or distributed. Although shown as a single medium, the machine-readable medium 1626 can include multiple media (e.g., a centralized/distributed database and/or associated caches and servers) that store one or more sets of instructions 1628. The machine-readable medium 1626 can include any medium that is capable of storing, encoding, or carrying a set of instructions for execution by the computing system 1600. The machine-readable medium 1626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 1610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1604, 1608, 1628) set at various times in various memory and storage devices in computing device(s). When read and executed by the processor 1602, the instruction(s) cause the computing system 1600 to perform operations to execute elements involving the various aspects of the disclosure.

### Further Examples

In some implementations, the techniques described herein relate to a computer-implemented method for generating pre-emptive informatics for virtual communication events, the method including retrieving, via an Application Programming Interface (API), time-indexed data corresponding to a user identifier, the time-indexed data including (1) at least one upcoming virtual communication event accessible to participant users associated with the user identifier, and (2) an event feature set indicating contextual metadata associated with the at least one upcoming virtual communication event. In some implementations, the method can include identifying, using the event feature set of the at least one upcoming virtual communication event, one or more prior virtual communication events associated with the at least one upcoming virtual communication event, each prior virtual communication event including a stored audio signal of the prior virtual communication event. In some implementations, the method can include extracting, from the stored audio signals of the one or more prior virtual communication events, a content signal set indicating historical event contents pertinent to the at least one upcoming virtual communication event. In some implementations, the method can include determining, from a remote database, at least one recorded digital artifact representing supplementary event contents that are similar to the extracted content signal set of the one or more prior virtual communication events. In some implementations, the method can include causing a generative machine learning model to generate a natural language response using the extracted content signal set and the at least one recorded digital artifact, the response indicating recommended user actions during the at least one upcoming virtual communication event. In some implementations, the method can include generating for display, at a user interface associated with the user identifier, the determined at least one recorded digital artifact and the generated natural language response.

In some implementations, the method can include determining, from the at least one recorded digital artifact, a historical digital artifact set, each historical digital artifact representing supplementary event contents for at least one prior virtual communication event of the one or more prior virtual communication events. In some implementations, the method can include generating for display, at the user interface, a graphical timeline that arranges the one or more prior virtual communication events in chronological order, the graphical timeline including a visual mapping between the one or more prior virtual communication events and the determined historical digital artifact set.

In some implementations, the method for extracting the content signal set can include converting the stored audio signals of the one or more prior virtual communication events into corresponding natural language transcripts, wherein each transcript is divided into one or more natural language segments associated with a timestamp and a speaker identifier. In some implementations, the method can include grouping, via a machine learning model, the one or more natural language segments into one or more content categories, wherein member natural language segments of each category share similar type of event information. In some implementations, the method can include causing the generative machine learning model to generate a response identifying at least one content signal for each of the one or more content categories, the at least one content signal indicating historical event information pertinent to the at least one upcoming virtual communication event.

In some implementations, the event feature set is a first event feature set, and wherein the method can include receiving, via the user interface, an updated time-indexed data corresponding to the user identifier, the updated time-indexed data including (1) a new virtual communication event accessible to participant users associated with the user identifier, and (2) a second event feature set indicating contextual metadata associated with the new virtual communication event. In some implementations, the method can include determining, via comparison of the first and the second event feature sets, an event dependency score indicating shared event contents between the at least one upcoming virtual communication event and the new virtual communication event. In some implementations, the method can include responsive to the event dependency score satisfying an alignment threshold, adding the new virtual communication event to the one or more prior virtual communication events associated with the at least one upcoming virtual communication event.

In some implementations, each prior virtual communication event includes a commentary feature set indicating participant feedback information associated with the prior virtual communication event, and the method can include, for each participant user of the at least one upcoming virtual communication event, identifying, from the commentary feature set, a commentary feature subset indicating participant feedback information corresponding to the participant user. In some implementations, the method can include accessing a stored profile representing event content preferences associated with the participant user, the stored profile including recorded user interactions of the participant user during the one or more prior virtual communication events. In some implementations, the method can include generating, using the stored profile of the participant user, a priority sequence for the identified commentary feature subset. In some implementations, the method can include determining, using the identified commentary feature subset and the priority sequence, one or more recorded digital artifacts representing supplementary event contents pertinent to the participant user for the at least one upcoming virtual communication event. In some implementations, the method can include causing the generative machine learning model to generate, using the determined one or more recorded digital artifacts and the stored profile of the participant user, a response indicating at least one personalized user action of the participant user for the upcoming virtual communication event.

In some implementations, the method can include receiving, from the user interface, a user query for information associated with a virtual communication event, the user query including a content feature set indicating contextual attributes associated with the user query. In some implementations, the method can include generating, using the content feature set of the received user query, a modified user query including a content feature subset that share content similarities to an event feature set of the virtual communication event. In some implementations, the method can include determining, via a semantic encoder, an embedded identifier for the modified user query based on the content feature subset. In some implementations, the method can include identifying, from the remote database, a digital artifact set representing supplemental event contents of prior virtual communication events, each digital artifact including an embedded content identifier that satisfies a similarity threshold in comparison with the embedded identifier for the modified user query. In some implementations, the method can include accessing a stored profile representing event content preferences associated with the user identifier. In some implementations, the method can include generating, using the stored profile of the user identifier, a priority sequence for the identified digital artifacts of the digital artifact set. In some implementations, the method can include causing the generative machine learning model to generate a response to the modified user query using the identified digital artifact set and the generated priority sequence for digital artifacts of the digital artifact set; and generating for display, at the user interface, the response to the modified user query.

In some implementations, the user query for content information is received during a real-time virtual communication event, and wherein the generative machine learning model is caused to generate a real-time response to the modified user query.

In some implementations, the recommended user actions of the generated natural language response include presentation of content information embedded in the at least one recorded digital artifact, participation in educational resources, proposal of enterprise activity, or a combination thereof.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any specific portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A computer-implemented method for generating pre-emptive informatics for virtual communication events, the method comprising:
retrieving, via an Application Programming Interface (API), time-indexed data corresponding to a user identifier, the time-indexed data comprising:
(1) at least one upcoming virtual communication event accessible to participant users associated with the user identifier, and
(2) an event feature set indicating contextual metadata associated with the at least one upcoming virtual communication event;
identifying, using the event feature set of the at least one upcoming virtual communication event, one or more prior virtual communication events associated with the at least one upcoming virtual communication event, each prior virtual communication event comprising a stored audio signal of the prior virtual communication event;
extracting, from the stored audio signals of the one or more prior virtual communication events, a content signal set indicating historical event contents pertinent to the at least one upcoming virtual communication event;
determining, from a remote database, at least one recorded digital artifact representing supplementary event contents that are similar to the extracted content signal set of the one or more prior virtual communication events;
causing a generative machine learning model to generate a natural language response using the extracted content signal set and the at least one recorded digital artifact, the response indicating recommended user actions during the at least one upcoming virtual communication event; and
generating for display, at a user interface associated with the user identifier, the determined at least one recorded digital artifact and the generated natural language response.

2. The computer-implemented method of claim 1, further comprising:
determining, from the at least one recorded digital artifact, a historical digital artifact set, each historical digital artifact representing supplementary event contents for at least one prior virtual communication event of the one or more prior virtual communication events; and
generating for display, at the user interface, a graphical timeline that arranges the one or more prior virtual communication events in chronological order, the graphical timeline comprising a visual mapping between the one or more prior virtual communication events and the determined historical digital artifact set.

3. The computer-implemented method of claim 1, wherein extracting the content signal set further comprises:
converting the stored audio signals of the one or more prior virtual communication events into corresponding natural language transcripts,
wherein each transcript is divided into one or more natural language segments associated with a timestamp and a speaker identifier;
grouping, via a machine learning model, the one or more natural language segments into one or more content categories,
wherein member natural language segments of each category share similar type of event information; and
causing the generative machine learning model to generate a response identifying at least one content signal for each of the one or more content categories, the at least one content signal indicating historical event information pertinent to the at least one upcoming virtual communication event.

4. The computer-implemented method of claim 1, wherein the event feature set is a first event feature set, and wherein the method further comprises:
receiving, via the user interface, an updated time-indexed data corresponding to the user identifier, the updated time-indexed data comprising: (1) a new virtual communication event accessible to participant users associated with the user identifier, and (2) a second event feature set indicating contextual metadata associated with the new virtual communication event;
determining, via comparison of the first and the second event feature sets, an event dependency score indicating shared event contents between the at least one upcoming virtual communication event and the new virtual communication event; and
responsive to the event dependency score satisfying an alignment threshold, adding the new virtual communication event to the one or more prior virtual communication events associated with the at least one upcoming virtual communication event.

5. The computer-implemented method of claim 1, wherein each prior virtual communication event comprises a commentary feature set indicating participant feedback information associated with the prior virtual communication event, and wherein the method further comprises:
for each participant user of the at least one upcoming virtual communication event:
identifying, from the commentary feature set, a commentary feature subset indicating participant feedback information corresponding to the participant user;
accessing a stored profile representing event content preferences associated with the participant user, the stored profile comprising recorded user interactions of the participant user during the one or more prior virtual communication events;
generating, using the stored profile of the participant user, a priority sequence for the identified commentary feature subset; and
determining, using the identified commentary feature subset and the priority sequence, one or more recorded digital artifacts representing supplementary event contents pertinent to the participant user for the at least one upcoming virtual communication event.

6. The computer-implemented method of claim 5, further comprising:
causing the generative machine learning model to generate, using the determined one or more recorded digital artifacts and the stored profile of the participant user, a response indicating at least one personalized user action of the participant user for the upcoming virtual communication event.

7. The computer-implemented method of claim 1, further comprising:
receiving, from the user interface, a user query for information associated with a virtual communication event, the user query comprising a content feature set indicating contextual attributes associated with the user query;
generating, using the content feature set of the received user query, a modified user query comprising a content feature subset that share content similarities to an event feature set of the virtual communication event;
determining, via a semantic encoder, an embedded identifier for the modified user query based on the content feature subset;
identifying, from the remote database, a digital artifact set representing supplemental event contents of prior virtual communication events, each digital artifact comprising an embedded content identifier that satisfies a similarity threshold in comparison with the embedded identifier for the modified user query;
accessing a stored profile representing event content preferences associated with the user identifier;
generating, using the stored profile of the user identifier, a priority sequence for the identified digital artifacts of the digital artifact set;
causing the generative machine learning model to generate a response to the modified user query using the identified digital artifact set and the generated priority sequence for digital artifacts of the digital artifact set; and
generating for display, at the user interface, the response to the modified user query.

8. The computer-implemented method of claim 7, wherein the user query for content information is received during a real-time virtual communication event, and wherein the generative machine learning model is caused to generate a real-time response to the modified user query.

9. The computer-implemented method of claim 1, wherein the recommended user actions of the generated natural language response include presentation of content information embedded in the at least one recorded digital artifact, participation in educational resources, proposal of enterprise activity, or a combination thereof.

10. A system comprising:
at least one hardware processor; and
at least one non-transitory memory storing instructions, which, when executed by the at least one hardware processor, cause the system to:
retrieve time-indexed data corresponding to a user identifier, the time-indexed data comprising:
(1) at least one upcoming virtual communication event accessible to participant users associated with the user identifier, and
(2) an event feature set indicating contextual metadata associated with the at least one upcoming virtual communication event;
identify, using the event feature set of the at least one upcoming virtual communication event, one or more prior virtual communication events associated with the at least one upcoming virtual communication event, each prior virtual communication event comprising a stored audio signal of the prior virtual communication event;
extract, from the stored audio signals of the one or more prior virtual communication events, a content signal set indicating historical event contents pertinent to the at least one upcoming virtual communication event;
determine at least one recorded digital artifact representing supplementary event contents that are similar to the extracted content signal set of the one or more prior virtual communication events;
cause a generative machine learning model to generate a natural language response using the extracted content signal set and the at least one recorded digital artifact, the response indicating recommended user actions during the at least one upcoming virtual communication event; and
generate for display, at a user interface associated with the user identifier, the determined at least one recorded digital artifact and the generated natural language response.

11. The system of claim 10, further caused to:
determine, from the at least one recorded digital artifact, a historical digital artifact set, each historical digital artifact representing supplementary event contents for at least one prior virtual communication event of the one or more prior virtual communication events; and
generate for display, at the user interface, a graphical timeline that arranges the one or more prior virtual communication events in chronological order, the graphical timeline comprising a visual mapping between the one or more prior virtual communication events and the determined historical digital artifact set.

12. The system of claim 10, further caused to:
convert the stored audio signals of the one or more prior virtual communication events into corresponding natural language transcripts,
wherein each transcript is divided into one or more natural language segments associated with a timestamp and a speaker identifier;
group, via a machine learning model, the one or more natural language segments into one or more content categories,
wherein member natural language segments of each category share similar type of event information; and
cause the generative machine learning model to generate a response identifying at least one content signal for each of the one or more content categories, the at least one content signal indicating historical event information pertinent to the at least one upcoming virtual communication event.

13. The system of claim 10, wherein the event feature set is a first event feature set, and wherein the system is further caused to:
receive, via the user interface, an updated time-indexed data corresponding to the user identifier, the updated time-indexed data comprising: (1) a new virtual communication event accessible to participant users associated with the user identifier, and (2) a second event feature set indicating contextual metadata associated with the new virtual communication event;
determine, via comparison of the first and the second event feature sets, an event dependency score indicating shared event contents between the at least one upcoming virtual communication event and the new virtual communication event; and
responsive to the event dependency score satisfying an alignment threshold, add the new virtual communication event to the one or more prior virtual communication events associated with the at least one upcoming virtual communication event.

14. The system of claim 10, wherein each prior virtual communication event comprises a commentary feature set indicating participant feedback information associated with the prior virtual communication event, and wherein the system is further caused to:
for each participant user of the at least one upcoming virtual communication event:
identify, from the commentary feature set, a commentary feature subset indicating participant feedback information corresponding to the participant user;
access a stored profile representing event content preferences associated with the participant user, the stored profile comprising recorded user interactions of the participant user during the one or more prior virtual communication events;
generate, using the stored profile of the participant user, a priority sequence for the identified commentary feature subset; and
cause the generative machine learning model to selectively identify, using the identified commentary feature subset and the priority sequence, one or more recorded digital artifacts representing supplementary event contents pertinent to the participant user for the at least one upcoming virtual communication event.

15. The system of claim 10, further caused to:
receive, from the user interface, a user query for information associated with a virtual communication event, the user query comprising a content feature set indicating contextual attributes associated with the user query;
generate, using the content feature set of the received user query, a modified user query comprising a content feature subset that share content similarities to an event feature set of the virtual communication event;
determine, via a semantic encoder, an embedded identifier for the modified user query based on the content feature subset;
identify a digital artifact set representing supplemental event contents of prior virtual communication events, each digital artifact comprising an embedded content identifier that satisfies a similarity threshold in comparison with the embedded identifier for the modified user query;
access a stored profile representing event content preferences associated with the user identifier;
generate, using the stored profile of the user identifier, a priority sequence for the identified digital artifacts of the digital artifact set;
cause the generative machine learning model to generate a response to the modified user query using the identified digital artifact set and the generated priority sequence for digital artifacts of the digital artifact set; and
generate for display, at the user interface, the response to the modified user query.

16. A non-transitory computer-readable storage medium comprising instructions recorded thereon, wherein the instructions when executed by at least one data processor of a system, cause the system to:
retrieve time-indexed data corresponding to a user identifier, the time-indexed data comprising:
(1) at least one upcoming virtual communication event accessible to participant users associated with the user identifier, and
(2) an event feature set indicating contextual metadata associated with the at least one upcoming virtual communication event;
identify, using the event feature set of the at least one upcoming virtual communication event, one or more prior virtual communication events associated with the at least one upcoming virtual communication event, each prior virtual communication event comprising a stored audio signal of the prior virtual communication event;
extract, from the stored audio signals of the one or more prior virtual communication events, a content signal set indicating historical event contents pertinent to the at least one upcoming virtual communication event;
determine at least one recorded digital artifact representing supplementary event contents that are similar to the extracted content signal set of the one or more prior virtual communication events;
cause a generative machine learning model to generate a natural language response using the extracted content signal set and the at least one recorded digital artifact, the response indicating recommended user actions during the at least one upcoming virtual communication event; and
generate for display, at a user interface associated with the user identifier, the determined at least one recorded digital artifact and the generated natural language response.

17. The non-transitory computer-readable storage medium of claim 16, wherein the system is further caused to:
determine, from the at least one recorded digital artifact, a historical digital artifact set, each historical digital artifact representing supplementary event contents for at least one prior virtual communication event of the one or more prior virtual communication events; and
generate for display, at the user interface, a graphical timeline that arranges the one or more prior virtual communication events in chronological order, the graphical timeline comprising a visual mapping between the one or more prior virtual communication events and the determined historical digital artifact set.

18. The non-transitory computer-readable storage medium of claim 16, wherein the system is further caused to:
convert the stored audio signals of the one or more prior virtual communication events into corresponding natural language transcripts,
wherein each transcript is divided into one or more natural language segments associated with a timestamp and a speaker identifier;
group, via a machine learning model, the one or more natural language segments into one or more content categories,
wherein member natural language segments of each category share similar type of event information; and
cause the generative machine learning model to generate a response identifying at least one content signal for each of the one or more content categories, the at least one content signal indicating historical event information pertinent to the at least one upcoming virtual communication event.

19. The non-transitory computer-readable storage medium of claim 16, wherein the event feature set is a first event feature set, and wherein the system is further caused to:
receive, via the user interface, an updated time-indexed data corresponding to the user identifier, the updated time-indexed data comprising: (1) a new virtual communication event accessible to participant users associated with the user identifier, and (2) a second event feature set indicating contextual metadata associated with the new virtual communication event;
determine, via comparison of the first and the second event feature sets, an event dependency score indicating shared event contents between the at least one upcoming virtual communication event and the new virtual communication event; and
responsive to the event dependency score satisfying an alignment threshold, add the new virtual communication event to the one or more prior virtual communication events associated with the at least one upcoming virtual communication event.

20. The non-transitory computer-readable storage medium of claim 16, wherein each prior virtual communication event comprises a commentary feature set indicating participant feedback information associated with the prior virtual communication event, and wherein the system is further caused to:
for each participant user of the at least one upcoming virtual communication event:
identify, from the commentary feature set, a commentary feature subset indicating participant feedback information corresponding to the participant user;
access a stored profile representing event content preferences associated with the participant user, the stored profile comprising recorded user interactions of the participant user during the one or more prior virtual communication events;
generate, using the stored profile of the participant user, a priority sequence for the identified commentary feature subset; and
cause the generative machine learning model to selectively identify, using the identified commentary feature subset and the priority sequence, one or more recorded digital artifacts representing supplementary event contents pertinent to the participant user for the at least one upcoming virtual communication event.
